(19) United States
(12) Patent Application Publication
(10) Pub. No.: US 2026/0238727 A1
(43) Pub. Date: Aug. 13, 2026

(54) DOCUMENT PROCESSING APPARATUS, IMAGE FORMING APPARATUS, AND IMAGE FORMING SYSTEM

(71) Applicant: Jun YAMADA, Kanagawa (JP)

(72) Inventor: Jun YAMADA, Kanagawa (JP)

(73) Assignee: ETRIA Co., Ltd., Kanagawa (JP)

(21) Appl. No.: 19/432,800

(22) Filed: Dec. 24, 2025

(30) Foreign Application Priority Data
Feb. 7, 2025 (JP) 2025-019529

(51) Int. Cl. H04N 1/00; G03G 15/00; G03G 15/22; H04R 1/08

(52) U.S. Cl. CPC H04N 1/00087; G03G 15/228; G03G 15/50; H04N 1/00034; H04N 1/00074; H04N 1/00323; H04N 1/0057; H04N 2201/0081; H04N 2201/0094; H04R 1/08

(57) ABSTRACT

A document processing apparatus includes a tray, a conveyor, a reader, and circuitry. The tray stacks a document. The conveyor conveys the document from the tray. The reader reads an image on the document conveyed by the conveyor. The circuitry is to acquire processing information including a conveyance setting to set a conveyance condition of the document by the conveyor or a reading setting to set a reading condition of the document by the reader, estimate, based on the processing information acquired, magnitude of a sound generated by a conveyance of the document by the conveyor or a reading of the document by the reader and a reading number of sheets of the document processable per a given period of time, and change the conveyance setting based on the magnitude of the sound and the reading number.

### CROSS-REFERENCE TO RELATED APPLICATION

This patent application is based on and claims priority pursuant to 35 U.S.C. § 119(a) to Japanese Patent Application No. 2025-019529, filed on Feb. 7, 2025, in the Japan Patent Office, the entire disclosure of which is hereby incorporated by reference herein.

### BACKGROUND

### Technical Field

Embodiments of the present disclosure relate to a document processing apparatus, an image forming apparatus, and an image forming system.

### Related Art

Typical apparatuses including a document processing apparatus are arranged in various environments. In a case of arranging the apparatuses in a relatively quiet environment such as an office, a sound to be generated is considered.

An image forming apparatus in the art including an image reader proposes a technique that acquires a noise value generated according to an operation mode and changes the operation mode so as to reduce the noise value.

However, according to the image forming apparatus in the art, although the operation mode for reducing the noise value (decibel) is changed, a change in reading productivity due to the changed operation mode has not been considered. In other words, the reading productivity can be lowered more than necessary when the operation mode is changed.

### SUMMARY

Embodiments of the present disclosure described herein provide a novel document processing apparatus including a tray, a conveyor, a reader, and circuitry. The tray stacks a document. The conveyor conveys the document from the tray. The reader reads an image on the document conveyed by the conveyor. The circuitry is to acquire processing information including a conveyance setting to set a conveyance condition of the document by the conveyor or a reading setting to set a reading condition of the document by the reader, estimate, based on the processing information acquired, magnitude of a sound generated by a conveyance of the document by the conveyor or a reading of the document by the reader and a reading number of sheets of the document processable per a given period of time, and change the conveyance setting based on the magnitude of the sound and the reading number.

Further, embodiments of the present disclosure described herein provide an image forming apparatus including an interface and circuitry. The interface communicably couples to a document processing apparatus including a tray, a conveyor, and a reader. The tray stacks a document. The conveyor conveys the document from the tray. The reader reads an image on the document conveyed by the conveyor. The circuitry is to acquire processing information including a conveyance setting to set a conveyance condition of the document by the conveyor or a reading setting to set a reading condition of the document by the reader and estimate, based on the processing information acquired, magnitude of a sound generated by a conveyance of the document by the conveyor or a reading of the document by the reader and a reading number of sheets of the document processable per a given period of time, and change the conveyance setting based on the magnitude of the sound and the reading number.

Further, embodiments of the present disclosure described herein provide an image forming system includes an image forming apparatus and a document processing apparatus. The image forming apparatus includes a drive mechanism to drive to form an image. The document processing apparatus includes a tray, a conveyor, a reader, an interface, and circuitry. The tray stacks a document. The conveyor conveys the document from the tray. The reader reads an image on the document conveyed by the conveyor. The interface communicably couples to the image forming apparatus. The circuitry is to acquire processing information including a conveyance setting to set a conveyance condition of the document by the conveyor or a reading setting to set a reading condition of the document by the reader, estimate, based on the processing information acquired, magnitude of a sound generated by a conveyance of the document by the conveyor or a reading of the document by the reader and a reading number of sheets of the document processable per a given period of time, transmit information based on an estimation result of the magnitude of the sound and the reading number of sheets of the document processable per a given period of time, to the image forming apparatus, and cause the image forming apparatus to change a control of the drive mechanism based on the information received by the circuitry.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic configuration diagram illustrating a copier according to an embodiment;

FIG. 2 is a partial configuration diagram illustrating a part of an internal configuration of an image forming apparatus according to an embodiment;

FIG. 3 is a partially enlarged view illustrating a part of a tandem section according to an embodiment;

FIG. 4 is a perspective view illustrating a scanner and an automatic document feeder (ADF) of the copier according to an embodiment;

FIG. 5 is an enlarged view of a configuration of an ADF with a scanner of an image forming apparatus according to an embodiment;

FIG. 6 is a diagram illustrating a configuration example of a copier according to a first embodiment;

FIG. 7 is a diagram illustrating estimation of a noise value, acoustic comfort index, and productivity by a trained model according to the first embodiment;

FIG. 8 is a diagram illustrating an example of a functional configuration of a document processing system according to the first embodiment;

FIG. 9 is a flowchart illustrating a procedure of document processing in a controller of the ADF according to the first embodiment;

FIGS. 10A, 10B and 10C are diagrams illustrating an example of a screen related to document processing of the ADF according to the first embodiment;

FIG. 11 is an explanatory diagram illustrating estimation of a noise value, acoustic comfort index, and productivity for each document processing information by an estimation unit according to the first embodiment;

FIG. 12 is a flowchart illustrating a procedure of document processing in a controller of an ADF according to a modification;

FIG. 13 is an explanatory diagram illustrating a training phase until the information processing apparatus according to the first embodiment generates a trained model and implements the trained model on the ADF;

FIG. 14 is a flowchart illustrating a procedure of collecting information for generating training data according to the first embodiment;

FIG. 15 is a diagram illustrating a structure of training data according to the first embodiment;

FIG. 16 is a flowchart illustrating a procedure of generating a trained model in the information processing apparatus according to the first embodiment;

FIG. 17 is a diagram illustrating a configuration example of a copier according to a second embodiment; and

FIG. 18 is a diagram illustrating a configuration example of a copier and a cloud server according to a third embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

Hereinafter, embodiments of a document processing apparatus, an image forming apparatus, a learned model generation apparatus, and an image forming system according to the present invention will be described in detail with reference to the accompanying drawings.

### First Embodiment

The copier according to the present embodiment may use, for example, a composite function full-color digital copier (Multifunction Peripheral/Product/Printer (MFP)) that forms a color image by an electrophotographic method.

An embodiment using an electrophotographic copier (simply referred to as copier) is described below.

A description is now given of the basic configuration of a copier as an image forming apparatus according to the present embodiment.

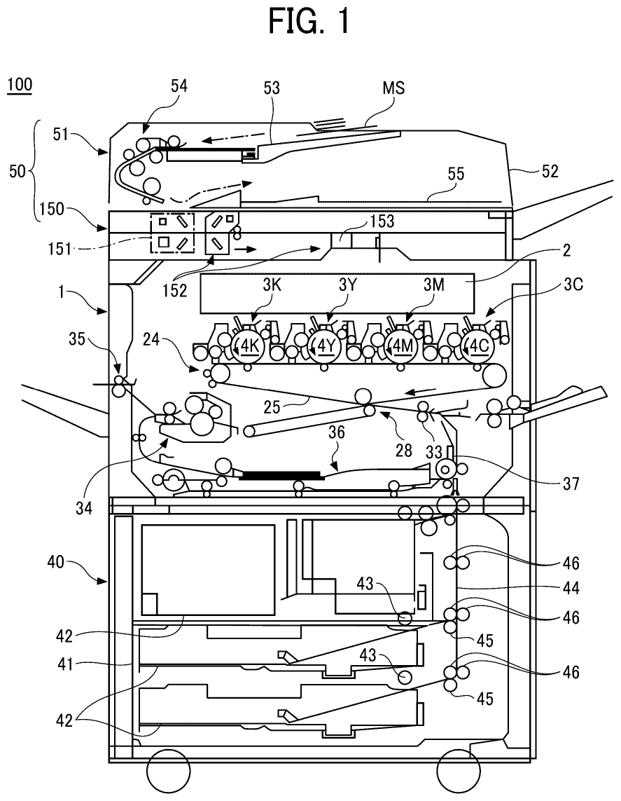

FIG. 1 is a diagram illustrating a schematic configuration of a copier according to an embodiment of the present disclosure.

In the example of FIG. 1, the copier 100 includes an image forming apparatus 1 as an image forming apparatus, a sheet feeding apparatus 40, and an image reading system 50. The image reading system 50 includes a scanner 150 as an image reading device fixed on the image forming apparatus 1, and a document processing apparatus (referred to as ADF) 51 supported by the scanner 150.

The sheet feeding device 40 includes a sheet bank 41, two sheet trays 42 disposed in multistage one above the other in the sheet bank 41, sheet feed rollers 43 each of which picking up a recording sheet from a selected one of the two sheet trays 42, and sheet separation rollers 45 each of which separating multiple recording sheets fed by the feed rollers 43. The sheet feeding device 40 also includes a plurality of conveyance roller pairs 46 for conveying a recording sheet to a sheet conveyance path 37 as a conveyance passage of the image forming apparatus 1.

Each of the two sheet trays 42 accommodates multiple recording sheets overlapping each other in a form of a sheet bundle. The sheet feed roller 43 press-contacts the uppermost sheet of the multiple recording sheets in each of the two sheet trays 42. As the sheet feed roller 43 rotates, the uppermost recording sheet of the sheet bundle is fed from the selected one of the sheet trays 42.

The multiple conveyance roller pairs 46 are disposed near the multiple sheet trays 42. Each of the multiple conveyance roller pairs 46 includes a first conveyance roller and a second conveyance roller adjacent to (on the right side of FIG. 1 of) the first conveyance roller. The first conveyance roller and the second conveyance roller of each of the multiple conveyance roller pairs 46 are in contact with each other to form a conveyance nip region.

A sheet separation roller 45 is disposed below the first conveyance roller of each of the multiple conveyance roller pairs 46 and is in contact with the first conveyance roller from below to form a separation conveyance nip region.

A recording sheet fed from one of the sheet trays 42 driven and rotated by a corresponding one of the sheet feed rollers 43 enters the separation conveyance nip region formed by the contact of the first conveyance roller of a conveyance roller pair 46 and a sheet separation roller 45 disposed below the first conveyance roller. In the separation conveyance nip region, the first conveyance roller that contacts the upper face of the recording sheet applies a conveyance force to the recording sheet from the sheet tray 42 toward a sheet feeding path 44 as the first conveyance roller is driven and rotated in the counterclockwise direction in FIG. 1. In contrast, the sheet separation roller 45 that is in contact with the lower face of the recording sheet applies a conveyance force to the recording sheet from the sheet feeding path 44 toward the sheet tray 42 as the sheet separation roller 45 is driven and rotated in the counterclockwise direction in FIG. 1. By so doing, the recording sheet is returned to the sheet tray 42.

When only one recording sheet is fed from the sheet tray 42, the first conveyance roller of the conveyance roller pair 46 and the sheet separation roller 45 apply the conveyance force to the recording sheet toward opposite directions to each other in the separation conveyance nip region. As a result, a load exceeding a given threshold value is applied to the drive transmission part of the sheet separation roller 45. Then, a torque limiter disposed in the drive transmission part of the sheet separation roller 45 is operated to cut off the transmission of the driving force from a direct current (DC) brushless motor to the sheet separation roller 45. Accordingly, the sheet separation roller 45 is rotated with the recording sheet that is conveyed by the first conveyance roller, and the recording sheet is then ejected from the separation conveyance nip region to the sheet feeding path 44.

On the other hand, when the multiple recording sheets are fed from the sheet tray 42 with the multiple recording sheets overlapped to each other, the first conveyance roller applies the conveyance force to the uppermost recording sheet of the multiple recording sheets from the sheet tray 42 toward the sheet feeding path 44 in the separation conveyance nip region. The uppermost recording sheet of the multiple recording sheets is fed from the separation conveyance nip region toward the sheet feeding path 44. On the other hand, the sheet separation roller 45 applies the conveyance force from the sheet feeding path 44 toward the sheet tray 42 to the lower recording sheet or sheets of the multiple recording sheets, so that the lower recording sheet is (or sheets are) reversed from the separation conveyance nip region toward the sheet tray 42. Accordingly, in the separation conveyance nip region, the uppermost recording sheet is separated from other recording sheet or sheets so as to be conveyed alone to the sheet feeding path 44.

The recording sheet on the sheet feeding path 44 enters the conveyance nip region of the conveyance roller pair 46 where the conveyance force is applied upward from below in the vertical direction. As a result, in the sheet feeding path 44, the recording sheet is conveyed toward the sheet conveyance path 37 of the image forming apparatus 1.

The image forming apparatus 1 includes, for example, an optical writing device 2, and four image forming units 3K, 3Y, 3M, and 3C that form toner images of black (K), yellow (Y), magenta (M), and cyan (C).

The image forming apparatus 1 further includes a transfer unit 24, a sheet conveyance unit 28, a registration roller pair 33, a fixing device 34, a switchback device 36, and the sheet conveyance path 37. Then, by driving a light source such as a laser diode or an LED disposed in the optical writing device 2, the optical writing device 2 irradiates four drum-shaped photoconductors 4K, 4Y, 4M, and 4C with a laser light L. By the irradiation of the laser light L, electrostatic latent images are formed on the surfaces of the photoconductors 4K, 4Y, 4M, and 4C. This electrostatic latent image is developed into a visible toner image through a given development process.

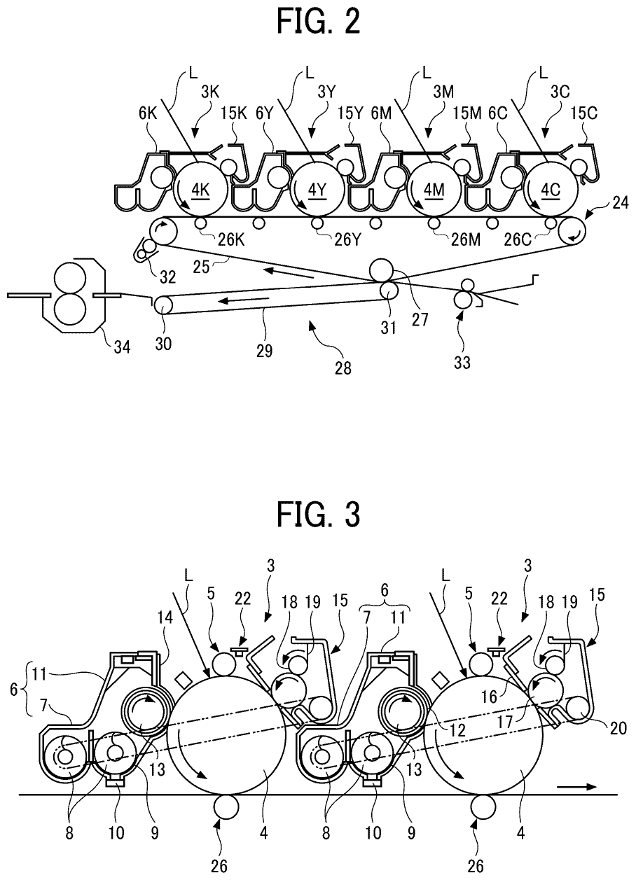

FIG. 2 is a partial configuration diagram illustrating a part of an internal configuration of an image forming apparatus according to an embodiment of the present disclosure.

FIG. 3 is a partially enlarged view of a part of a tandem section including an image forming units 3K, 3Y, 3M and 3C according to an embodiment of the present disclosure.

Since the four image forming units 3K, 3Y, 3M and 3C of a tandem section have respective configurations substantially the same as each other except the toner colors, the image forming units 3K, 3Y, 3M, and 3C are also described without suffixes indicating the toner colors, which are K, Y, M and C in FIG. 3. For example, the image forming units 3K, 3Y, 3M and 3C may be also referred to as an “image forming unit 3” in a single form.

The image forming units 3K, 3Y, 3M, and 3C respectively support the photoconductors 4K, 4Y, 4M, and 4C and various devices disposed around the photoconductors 4K, 4Y, 4M, and 4C as one unit on a common support, and are detachable from the main body of the image forming apparatus 1. The image forming unit 3 (i.e., the image forming units 3K, 3Y, 3M and 3C) includes the photoconductor 4 (i.e., the photoconductors 4K, 4Y, 4M and 4C), and a charging device 5, a developing device 6 (i.e., developing devices 6K, 6Y, 6M and 6C), a drum cleaning device 15 (i.e., drum cleaning devices 15K, 15Y, 15M and 15C), and an electric discharging lamp 22 around the photoconductor 4. The copier 100 is a tandem image forming system in which the four image forming units 3K, 3Y, 3M and 3C are aligned in a direction of movement of an intermediate transfer belt 25 as an endless loop, which is described below.

The photoconductors 4K, 4Y, 4M and 4C are each manufactured by a hollow tube made of aluminum, for example, with a drum shape covered by an organic photoconductive layer having photosensitivity. Alternatively, the photoconductors 4K, 4Y, 4M and 4C may have an endless belt shape.

The developing device 6 (i.e., developing devices 6K, 6Y, 6M and 6C) develops an electrostatic latent image into a visible toner image by a two-component developer including magnetic carrier particles and non-magnetic toner. The two-component developer is now referred to as a “developer”. The developing device 6 includes an agitating portion 7 and a development portion 11. The agitating portion 7 stirs the two-component developer accommodated therein and conveys the two-component developer to a development sleeve 12. The development portion 11 supplies the non-magnetic toner, which is included in the two-component developer and held by the development sleeve 12, to the photoconductor 4 (i.e., photoconductors 4K, 4Y, 4M, and 4C).

The agitating portion 7 is located at a position lower than the development portion 11 and includes two screws, a partition, a development case 9, and a toner concentration sensor 10. The two transfer screws 8 are disposed in parallel to each other. The partition is disposed between the two transfer screws 8. The development case 9 has an opening or a slot to face the photoconductor 4. The toner concentration sensor 10 is disposed on the bottom of the development case 9.

The development portion 11 includes the development sleeve 12, a magnetic roller 13, and a doctor blade 14. The development sleeve 12 faces the photoconductor 4 (i.e., the photoconductors 4K, 4Y, 4M and 4C) through the opening (or the slot) of the development case 9. The magnetic roller 13 is fixedly or unrotatably disposed inside the development sleeve 12. The doctor blade 14 is disposed adjacent to the development sleeve 12 and the leading end of the doctor blade 14 is disposed close to the development sleeve 12. The development sleeve 12 has a non-magnetic, rotatable tubular body.

The magnetic roller 13 has multiple magnetic poles arranged in the order in a rotation direction of the development sleeve 12, starting from an opposed position to the doctor blade 14. Each of these magnetic poles applies a magnetic force at a given position in the rotation direction of the development sleeve 12, with respect to the two-component developer supplied on the development sleeve 12. With this action of the magnetic roller 13, the two-component developer that is conveyed from the agitating portion 7 is attracted and attached to the surface of the development sleeve 12 and a magnetic brush of toner is formed along the lines of the magnetic force on the surface of the development sleeve 12.

In accordance with rotation of the development sleeve 12, the magnetic brush is restricted to have an appropriate layer thickness when passing by the opposed position to the doctor blade 14. Then, the magnetic brush is moved to a development region facing the photoconductors 4K, 4Y, 4M and 4C. Due to a difference of potentials between a development bias that is applied to the development sleeve 12 and an electrostatic latent image formed on the surface of the photoconductor 4 (i.e., the photoconductors 4K, 4Y, 4M and 4C), the toner is transferred onto the electrostatic latent image, so that the electrostatic latent image is developed into a visible toner image.

Further, after returning into the development portion 11 again along with the rotation of the development sleeve 12 then leaving from the surface of the development sleeve 12 due to repulsion of the magnetic field formed between the magnetic poles of the magnetic roller 13, the two-component developer in a form of the magnetic brush is returned to the agitating portion 7. An appropriate amount of toner is supplied to the two-component developer in the agitating portion 7 based on a result or results detected by the toner concentration sensor 10. Alternative to the two-component developer, the developing device 6 according to the present embodiment may employ one-component developer that does not include magnetic carriers.

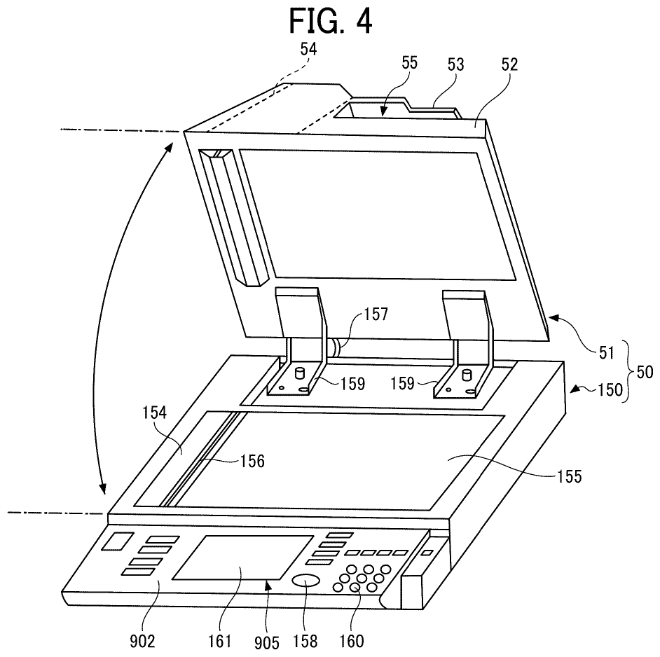

The drum cleaning device 15 (i.e., drum cleaning devices 15K, 15Y, 15M and 15C) includes a cleaning blade 16, a fur brush 17, an electric field roller 18, a scraper 19, a collection screw 20, and an outside recycle toner device 21. The cleaning blade 16 is an elastic member to be pressed against the photoconductor 4, so as to scrape residual toner remaining on the surface of the photoconductor 4. In the present embodiment, the drum cleaning device 15 employs a blade member such as the cleaning blade 16, however, the configuration is not limited thereto. Alternative to the blade member, a brush roller, for example, can be applied to the drum cleaning device 15. The fur brush 17 according to the present embodiment is provided in order to increase the cleanability. The fur brush 17 is a conductive member and the outer circumferential surface of the fur brush 17 slidably contacts the photoconductor 4 (i.e., the photoconductors 4K, 4Y, 4M and 4C). The fur brush 17 according to the present embodiment is rotatable in a direction indicated by arrow in FIG. 4.

The fur brush 17 also functions as an applier that scrapes a solid lubricant to obtain fine powder of lubricant and applies the scraped fine powder to the surface of the photoconductor 4 (i.e., the photoconductors 4K, 4Y, 4M and 4C). The electric field roller 18 is a metallic member that applies a bias to the fur brush 17. The electric field roller 18 is disposed rotatably in a direction indicated by arrow in FIG. 3. The scraper 19 has a leading end that is pressed against the electric field roller 18. The toner removed from the photoconductor 4 and attached to the fur brush 17 is transferred onto the electric field roller 18 that contacts the fur brush 17 in a counter direction to be applied with a bias while the electric field roller 18 is rotating. After being scraped and removed from the electric field roller 18 by the scraper 19, the toner collected by the scraper 19 falls onto the collection screw 20. The collection screw 20 conveys the toner collected from the surface of the photoconductor 4 toward an end portion of the drum cleaning device 15 in a direction orthogonal to the drawing sheet, and transfers the collected toner to an external toner recycling transfer device. The external toner recycling transfer device sends the collected toner to the developing device 6 (i.e., developing devices 6K, 6Y, 6M and 6C) for recycling.

The electric discharging lamp 22 removes residual electric charge remaining on the surface of the photoconductors 4K, 4Y, 4M and 4C by photo irradiation. After such residual electric charge is removed, the electrically discharged surface of the photoconductor 4 (i.e., photoconductors 4K, 4Y, 4M and 4C) is uniformly charged by the charging device 5 again and then optically irradiated by the optical writing device 2. In the image forming apparatus 1 according to the present embodiment, the charging device 5 illustrated in FIG. 3 is a charging roller that is applied with charging bias and rotates while contacting the photoconductor 4 (i.e., the photoconductors 4K, 4Y, 4M and 4C). However, in some embodiments, the charging device 5 may be a scorotron charger that performs a charging process on the photoconductor 4 (i.e., the photoconductors 4K, 4Y, 4M and 4C) in non-contact with the photoconductor 4.

According to the above-described operations with the configuration illustrated in FIG. 2, black (K), yellow (Y), magenta (M), and cyan (C) toner images are formed on the photoconductors 4K, 4Y, 4M and 4C of the image forming units 3K, 3Y, 3M and 3C, respectively. The transfer unit 24 is disposed below the image forming units 3K, 3Y, 3M and 3C. The transfer unit 24 endlessly moves the intermediate transfer belt 25 in the clockwise direction in FIG. 2 while the intermediate transfer belt 25 is stretched by and would around multiple rollers and is in contact with the photoconductors 4K, 4Y, 4M and 4C. By so doing, respective primary transfer nip regions for forming black, yellow, magenta, and cyan images are formed between the photoconductors 4K, 4Y, 4M and 4C and the intermediate transfer belt 25 of an endless loop in contact with each other.

In proximity to each of the primary transfer nip regions for black, yellow, magenta, and cyan images, the primary transfer rollers 26 (i.e., the primary transfer rollers 26K, 26Y, 26M and 26C) are disposed in contact with the inner loop of the intermediate transfer belt 25 to press the intermediate transfer belt 25 against the photoconductors 4 (i.e., the photoconductors 4K, 4Y, 4M and 4C), respectively. A primary transfer bias is applied by respective transfer bias power supplies to the primary transfer rollers 26K, 26Y, 26M and 26C. Consequently, respective primary transfer electric fields are generated in the primary transfer nip regions for black, yellow, magenta, and cyan images to electrostatically transfer respective toner images formed on the photoconductors 4K, 4Y, 4M and 4C onto the intermediate transfer belt 25.

As the intermediate transfer belt 25 passes through the primary transfer nip regions for black, yellow, magenta, and cyan images along the endless rotation in the clockwise direction in FIG. 2, the black (K), yellow (Y), magenta (M) and cyan (C) toner images are sequentially transferred at the primary transfer nip regions and overlaid onto an outer circumferential surface of the intermediate transfer belt 25. Due to the primary transfer of the toner images, a four-color composite toner image (referred to as a four-color toner image) is formed on the outer circumferential surface of the intermediate transfer belt 25.

The sheet conveyance unit 28 is disposed below the transfer unit 24 in FIG. 2. The sheet conveyance unit 28 includes a sheet transfer belt 29, a sheet transfer belt drive roller 30, and a secondary transfer roller 31. The sheet transfer belt 29 is an endless belt that is wound around the sheet transfer belt drive roller 30 and the secondary transfer roller 31 and rotates in a direction indicated by arrow in FIG. 2. As illustrated in FIG. 2, the intermediate transfer belt 25 and the sheet transfer belt 29 are sandwiched between the secondary transfer roller 31 and a lower tension roller 27 of the transfer unit 24. According to this configuration, a secondary transfer nip region is formed between the surface of the intermediate transfer belt 25 and the surface of the sheet transfer belt 29 contacting with each other. A secondary transfer bias is applied by a transfer bias power supply to the secondary transfer roller 31. On the other hand, the lower tension roller 27 of the transfer unit 24 is electrically grounded. By so doing, a secondary transfer electric field is formed in the secondary transfer nip region.

The registration roller pair 33 is disposed on a right side of the secondary transfer nip region in FIG. 2. A registration roller sensor is disposed adjacent to an entrance of the registration nip region of the registration roller pair 33. The recording sheet is conveyed from the sheet feeding device 40 to the registration roller pair 33. After a given time has elapsed from the detection of the leading end of the recording sheet by the registration roller sensor, the conveyance of the recording sheet temporarily stops, and the leading end of the recording sheet contacts the registration nip region of the registration roller pair 33.

After the leading end of the recording sheet contacts the registration nip region of the registration roller pair 33, the registration roller pair 33 restarts the rotation to synchronize the movement of the recording sheet with the movement of the four-color toner image formed on the intermediate transfer belt 25. Consequently, the recording sheet nipped between the registration roller pair 33 is conveyed to the secondary transfer nip region. When the four-color toner image formed on the intermediate transfer belt 25 closely contacts the recording sheet at the secondary transfer nip region, the four-color toner image on the intermediate transfer belt 25 is transferred onto the recording sheet in the secondary transfer due to the secondary transfer electric field or the nip pressure. At this time, the four-color toner image is combined with white color of the recording medium to make a full-color image. After passing through the secondary transfer nip region, the recording sheet having the full-color toner image on the surface is separated from the intermediate transfer belt 25. Then, while being held on the front face of the sheet transfer belt 29, the recording sheet is conveyed to the fixing device 34 along with endless rotation of the sheet transfer belt 29 in the direction as illustrated in FIG. 2.

Residual toner that has not been transferred onto the recording sheet in the secondary transfer nip region remains on the surface of the intermediate transfer belt 25 after the intermediate transfer belt 25 has passed through the secondary transfer nip region. The residual toner is scraped and removed from the surface of the intermediate transfer belt 25 by a belt cleaning device 32 that is disposed in contact with the surface of the intermediate transfer belt 25.

The recording sheet is conveyed to the fixing device 34. The fixing device 34 fixes the full-color toner image to the recording sheet by application of heat and pressure. Then, the recording sheet is conveyed from the fixing device 34 to the sheet ejection roller pair 35 to be ejected to the outside of the image forming apparatus 1.

As illustrated in FIG. 1, the switchback device 36 is disposed below the sheet conveyance unit 28 and the fixing device 34. As a result of the above-described operation, after the image fixing operation is performed on one side or the surface of the recording sheet, a switching member switches the direction of conveyance of the recording sheet. Specifically, the direction of conveyance of the recording sheet is switched to a passage to the switchback device 36 by the switching member. When the recording sheet is conveyed to the transfer reversal device, the recording sheet is reversed to enter the secondary transfer nip region of the copier 100 again. In the image forming apparatus 1, a toner image is secondarily transferred onto the other side or a back face of the recording sheet so that the secondary transfer process and the fixing process are executed. Then, the recording sheet is ejected onto the ejection tray.

The scanner 150 fixed on the image forming apparatus 1 includes a movable reading unit 152 as a reader.

The scanner 150 and the ADF 51 include fixed reading units. The movable reading unit 152 is disposed immediately below a second exposure glass 155 (see FIG. 4) that is fixedly mounted on the upper wall of a casing of the scanner 150 so as to contact an original document MS. The movable reading unit 152 includes a light source and optical process units such as multiple reflection mirrors, so that these optical components can move in a horizontal direction (in other words, left and right directions) in FIG. 1. In the course of moving the optical components from left to right in FIG. 1, the light source emits the light. After a surface of the original document MS placed on the second exposure glass 155 reflects light, the reflected light is further reflected on multiple reflection mirrors until an image reading sensor 153 that is fixed to the scanner 150 receives the reflected light.

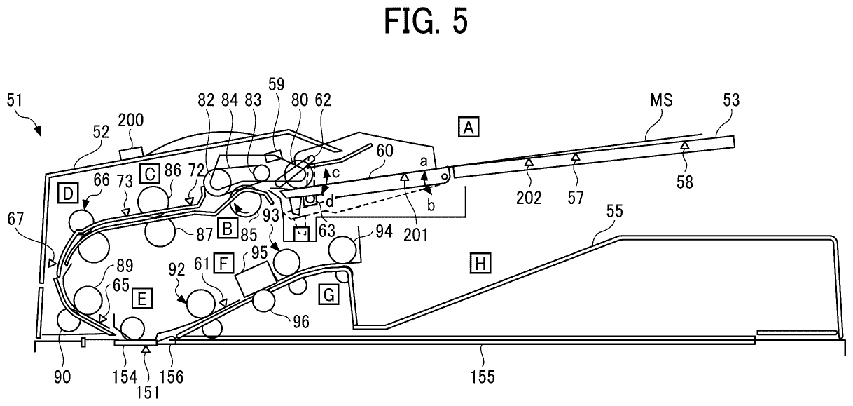

On the other hand, the fixed reading unit includes a first fixed reading unit 151 disposed inside the scanner 150 and a second fixed reading unit 95 (see FIG. 5) disposed in the ADF 51. The first fixed reading unit 151 including, for example, a light source, a reflection mirror, and an image reading sensor such as a CCD is disposed immediately below a first exposure glass 154 (see FIG. 4) fixed to a casing upper wall of the scanner 150 so as to be in contact with the original document MS. When the sheet-like original document MS that is conveyed by the ADF 51 (described below) passes over the first exposure glass 154, the light source emits light. After a document face of the original document MS sequentially reflects the light emitted from the light source, the reflected light is further reflected on multiple reflection mirrors until the image reading sensor 153 receives the reflected light. By so doing, the first face of the original document MS is scanned without moving the optical components such as the light source and the multiple reflection mirrors. The second fixed reading unit 95 scans the second face of the original document MS after passing through the first fixed reading unit 151. The first fixed reading unit 151 and the movable reading unit 152 may be the same. In this case, the movable reading unit 152 functions as the first fixed reading unit 151 (reader) by performing reading in a state of being under the first exposure glass 154.

The ADF 51 that is disposed on the scanner 150 includes a body cover 52, a document loading tray 53, a document conveyance unit 54, and a document stacking table 55. The body cover 52 holds and supports the document loading tray 53. The document loading tray 53 loads the original document MS to be read. The ADF 51 also holds and supports the document conveyance unit 54 and the document stacking table 55. The document conveyance unit 54 conveys the original document MS as a sheet member. The document stacking table 55 receives and stacks the original document MS after the original document MS is read.

FIG. 4 is a perspective view of a scanner and an automatic document feeder (ADF) of a copier according to an embodiment of the present disclosure.

As illustrated in FIG. 4, the ADF 51 is supported to be rotatable in the upward and downward directions by hinges 159 each being fixed to the scanner 150. With the rotation of the ADF 51 in the upward and downward directions, the ADF 51 works as an opening door, so that the first exposure glass 154 and the second exposure glass 155 on the upper face of the scanner 150 are exposed while the ADF 51 is open. In a case of the one-sided bound documents such as a book of a document bundle bounded on one-side, the original documents MS are not separated one by one. For this reason, the original documents MS in the above-described form are not conveyed by the ADF 51.

When reading the one-sided bound documents, the ADF 51 is opened as illustrated in FIG. 4. After the ADF 51 is opened as illustrated in FIG. 4, the one-sided bound documents are placed on the second exposure glass 155 with a page to be read facing down. Then, the ADF 51 is closed. Then, the scanner 150 causes the movable reading unit 152 illustrated in FIG. 1 to read the image on the page of the one-sided bound documents placed facedown.

On the other hand, in a case of a document bundle in which a plurality of documents MS independent from each other are stacked, while the documents MS are automatically conveyed one by one by the ADF 51, the first fixed reading unit 151 in the scanner 150 and the second fixed reading unit 95 (see FIG. 5) in the ADF 51 can sequentially read the documents MS.

In this case, a copy start key 158 is pressed after the bundle of original documents is placed on the document loading tray 53 of the ADF 51. Then, the ADF 51 starts conveyance of the original documents MS that are a bundle of original documents stacked on the document loading tray 53 to convey the original documents MS sequentially from top of the bundle of original documents MS to the document conveyance unit 54 one by one, and further convey the original documents MS to the document stacking table 55 while reversing the original document MS. In the process of the conveyance, immediately after the original document MS is inverted, the original document MS passes directly above the first fixed reading unit 151 of the scanner 150. At this time, the image of the first face of the original document MS is read by the first fixed reading unit 151 of the scanner 150.

FIG. 5 is an enlarged view of a configuration of the ADF 51 with the scanner 150 of the copier 100 according to an embodiment of the present disclosure.

The ADF 51 according to the present embodiment includes, for example, a document setting part A, a document separating and feeding part B, a registration part C, a document turning part D, a first reading and conveying part E, a second reading and conveying part F, a document ejecting part G, and a document stacking part H.

Further, the ADF 51 also provides a document conveyance passage for conveying the original document MS from the document loading tray 53 toward the first fixed reading unit 151 which is an image reading position.

The document setting part A has the document loading tray 53 on which a bundle of original documents MS is placed. The document separating and feeding part B separates and feeds the original document MS one by one from the bundle of the original documents MS set on the document loading tray 53. In the registration part C, the original document MS fed from the document separating and feeding part B temporarily contacts the original document MS to be aligned and fed again. The document turning part D has a conveyance passage curved in a C-shape, and turns the original document MS to be conveyed in the curved conveyance passage so as to reverse the original document MS upside down while turning the original document MS. The first reading and conveying part E causes the first fixed reading unit 151 disposed inside the scanner below the first exposure glass 154 to read the first face of the original document MS while conveying the original document MS on the first exposure glass 154. The second reading and conveying part F causes the second fixed reading unit 95 to read the second face of the original document MS while conveying the original document MS under the second fixed reading unit 95. After the images on both sides of the original document MS are read, the original document MS is conveyed in the document ejecting part G to be ejected toward the document stacking part H. In the document stacking part H, the original documents MS are placed and stacked on the document stacking table 55.

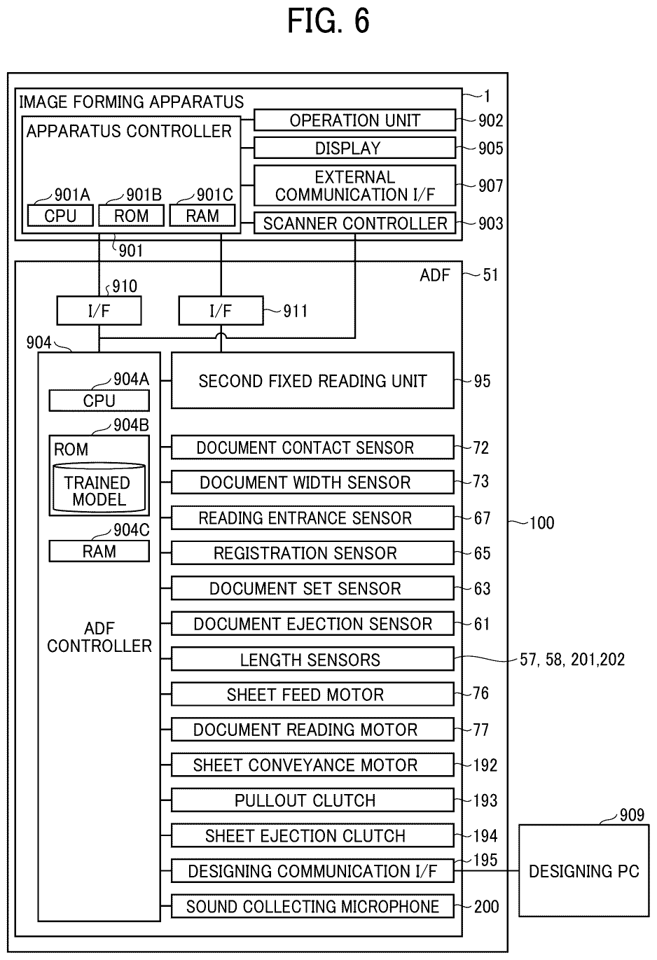

The original document MS is set in the document setting part A with the leading end of the original document MS placed on the movable document table 60 serving as a sheet tray rotatable in the directions indicated by arrows a and b in FIG. 5 depending on the thicknesses of a bundle of the original documents MS and the trailing end of the original document MS placed on the document loading tray 53. The side guides of the document loading tray 53 contact both lateral side ends of the original document MS in the width direction (i.e., the direction orthogonal to the drawing sheet) to adjust the position of the original document MS in the width direction. The original documents MS thus set push up a lever 62 that is rotatably disposed above the movable document table 60. Along with this movement of the original documents MS, a document set sensor 63 detects the setting of the original documents MS, and transmits the detection signal to the ADF controller 904 (see FIG. 6). The detection signal is then transmitted from the ADF controller 904 to a scanner controller 903 of the scanner via an interface (I/F).

The document loading tray 53 is a tray to which an original document as a reading target is set in the ADF 51.

The document loading tray 53 corresponds to, for example, the document setting part A.

A first length sensor 57, a second length sensor 58, a third length sensor 202, and a fourth length sensor 201 are held on the document loading tray 53. Each of the first length sensor 57, the second length sensor 58, the third length sensor 202, and the fourth length sensor 201 includes a reflective photosensor or an actuator-type sensor for detecting the length of the original document MS in the conveyance direction of the original document MS. The third length sensor 202 is, for example, a length sensor for a check. The fourth length sensor 201 is, for example, a length sensor for a business card. A description is given below of an example of the third length sensor 202 as a length sensor for a check and the fourth length sensor 201 as a length sensor for a business card.

The first length sensor 57, the second length sensor 58, the third length sensor 202, and the fourth length sensor 201 detect the length of the original document MS in the conveyance direction of the original document MS. The third length sensor 202 is disposed at a position where the third length sensor 202 is slightly not turned on when the check is placed on the document loading tray. The fourth length sensor 201 is arranged at a position where the fourth length sensor 201 is slightly not turned on when the business card is placed on the document loading tray.

Whether an original document of specified size such as a business card or a check is placed is detected from the detection information of the first length sensor 57, the second length sensor 58, the third length sensor 202, and the fourth length sensor 201. Since the length of a check is 185 mm and the length of a business card is 91 mm, the rough indication of the position of the third length sensor 202 is approximately 190 mm and the rough indication of the position of the fourth length sensor 201 is approximately 96 mm, with reference to the fence against which the leading end of the document set on the document loading tray contacts.

The pickup roller 80 is supported by the cam mechanism to be movable in the vertical direction (i.e., the directions indicated by arrows c and d in FIG. 5) and is disposed above the bundle of original documents MS stacked on the movable document table 60. The cam mechanism is driven by the pickup motor to move the pickup roller 80 in the vertical direction. As the pickup roller 80 moves upward, the movable document table 60 rotates in the direction indicated by arrow “a” in FIG. 5, so that the pickup roller 80 is brought to contact the uppermost original document MS placed on top of the bundle of original documents MS.

As the movable document table 60 further moves upward, a table elevation detection sensor 59 detects that the movable document table 60 moves up to the maximum height. In response to this detection, the pickup motor stops driving to stop the movable document table 60 from moving up.

A user (operator) performs a key operation for setting, for example, a reading mode indicating a double-sided reading mode or a single-sided reading mode, and a pressing operation of the copy start key 158 on an operation unit 902 including, for example, a numeric keypad 160 provided in a main body of the copier, and a touch panel 161 provided in a display 905. As the copy start key 158 is pressed by the user, the document feeding signal is sent to the ADF controller 904 of the ADF 51 from an apparatus controller 901 (see FIG. 6). In response to the sending of the document feeding signal, the pickup roller 80 is rotated along with the forward rotation of a sheet feed motor 76, so that the original documents MS on the movable document table 60 are fed from the movable document table 60.

The setting of the double-sided reading mode or the single-sided reading mode collectively covers the whole original documents MS stacked on the movable document table 60. To be more specific, when the double-sided reading mode or the single-sided reading mode is set, both sides or a single-side of the whole original documents MS stacked on the movable document table 60 can be read. In addition, individual reading mode setting can be performed on separate ones of the original documents MS. For example, the double-sided reading mode can be applied to the first and 10th original documents MS and the single-sided reading mode can be applied to the other original documents MS.

The original document MS sent by the pickup roller 80 enters the document separating and feeding part B and is sent to a contact position with the sheet feed belt 84. The sheet feed belt 84 is wound and stretched by, for example, a drive roller 82 to be endlessly moved in the clockwise direction in FIG. 5 by rotation of the drive roller 82 along with the forward rotation of the sheet feed motor 76. A separation roller 85 is in contact with the lower stretched face of the sheet feed belt 84 to be rotated in the clockwise direction in FIG. 5 along with the forward rotation of the sheet feed motor 76. At the contact portion, the sheet feed belt 84 is rotated so that the surface of the sheet feed belt 84 moves in the conveyance direction of the original document MS. The separation roller 85 is pressed against the sheet feed belt 84 with a given pressure. When the separation roller 85 directly contacts the sheet feed belt 84 or a single original document MS is nipped in the contact portion, the separation roller 85 is rotated with rotation of the sheet feed belt 84 or movement of the original document MS. However, when multiple original documents MS are nipped in the contact portion, the force of the separation roller 85 to be rotated with rotation of the sheet feed belt 84 or movement of the original document MS is lower than the torque of a torque limiter. For this reason, the separation roller 85 is rotated in the clockwise direction that is opposite to a direction in which the separation roller 85 is rotated. As a result, the separation roller 85 applies the force of movement in the direction opposite to the sheet conveyance direction, to the original documents MS under the uppermost original document MS, so that the uppermost original document MS along is separated from the multiple original documents MS under the uppermost original document MS. The above-described operation is referred to as a sheet feeding and separating operation.

The original document MS is separated from the other original documents MS through the operations of the sheet feed belt 84 and the separation roller 85, and enters the registration part C. Then, the leading end of the original document MS is detected by a document contact sensor 72 when the original document MS passes directly under the document contact sensor 72. At this time, the pickup roller 80 receiving the driving force of the pickup motor is still rotating. However, as the pickup roller 80 is separated from the original document MS due to descendance of the movable document table 60, the original document MS is conveyed only by an endless moving force of the sheet feed belt 84. Then, the endless movement of the sheet feed belt 84 is continued for a given time from the timing at which the leading end of the original document MS is detected by the document contact sensor 72. Then, the leading end of the original document MS contacts the contact portion of the pullout driven roller 87 and the pullout drive roller 86 that rotates while contacting the pullout drive roller 86. At this time, the contact portion of the pullout driven roller 87 and the pullout drive roller 86 is separated from the original document MS, from the timing at which the leading end of the original document MS is detected by the document contact sensor 72. By so doing, the timing to start conveying the original document MS by the endless movement force of the sheet feed belt 84 alone can be increased or decreased. By increasing or decreasing the timing to start conveying the original document MS by the endless movement force of the sheet feed belt 84 alone, the contact amount of the original document MS to contact the contact portion with the pullout driven roller 87 can be adjusted.

If the speed of the original document MS at this time is 500 mm/s, the contact amount can be increased by 1 mm by delaying the timing to separate the contact portion from the original document MS by 2 msec. The equation is expressed by (500 mm/sec×0.002 sec=1 mm).

The pullout driven roller 87 has a function of conveying the original document MS to the intermediate roller pair 66 downstream from the pullout driven roller 87 in the document conveyance direction, and is driven and rotated by the rotation of the sheet feed motor 76 in the reverse direction. As the sheet feed motor 76 rotates in the reverse direction, the pullout driven roller 87 and one roller of the intermediate roller pair 66 contacting the pullout driven roller 87 start rotating and the endless movement of the sheet feed belt 84 stops. At this time, the pickup roller 80 stops rotating.

The original document MS that is fed by the pullout driven roller 87 passes directly under a document width sensor 73. The document width sensor 73 includes multiple sheet detectors each including a reflective photosensor. The multiple sheet detectors are aligned in a row in the width direction of the original document MS (i.e., the direction perpendicular to the drawing sheet of FIG. 5). The size of the original document MS in the width direction is detected based on which one of the multiple sheet detectors detects the original document MS. The length of the original document MS in the document conveyance direction is detected based on the time from when the leading end of the original document MS is detected by the document contact sensor 72 to when the trailing end of the original document MS is not detected by the document contact sensor 72.

The leading end of the original document MS whose size in the width direction is detected by the document width sensor 73 enters the document turning part D and is nipped by the contact portion between the rollers of the intermediate roller pair 66. The conveyance speed of the original document MS conveyed by the intermediate roller pair 66 is set faster than the conveyance speed of the original document MS in the first reading and conveying part E that will be described below. This configuration achieves a reduction in time for conveying the original document MS to the first reading and conveying part E.

As described above, the size of an original document MS can be detected by the document width sensor 73, the first length sensor 57, the second length sensor 58, the third length sensor 202, and the fourth length sensor 201. On the other hand, the user can also designate the size (reading size) of the original document MS with the operation unit 902. For example, the user can select and designate the sizes of business cards (55 mm×91 mm) and checks (85 mm×185 mm) from among options for all sizes.

The leading end of the original document MS conveyed in the document turning part D passes through a position facing a reading entrance sensor 67. As a result, when the leading end of the original document MS is detected by the reading entrance sensor 67, the conveyance speed of the original document MS by the intermediate roller pair 66 is reduced until the leading end is conveyed to the position of a scan entrance roller pair (the pair of 89 and 90) on the downstream side in the document conveyance direction. As a document reading motor 77 (see FIG. 6) starts to drive and rotate, one roller of the scan entrance roller pair, one roller of a scan exit roller pair 92, and one roller of a second scan exit roller pair 93 respectively start the rotations.

In the document turning part D, while the original document MS is conveyed in the curved conveyance passage between the intermediate roller pair 66 and the scan entrance roller pair, the upper and lower faces of the original document MS are reversed, and the conveyance direction of the original document MS is turned back. Then, the leading end of the original document MS that has passed through the nip region between the rollers of the scan entrance roller pair passes directly under a registration sensor 65. The operation up to this point after the sheet feeding and separating operation is referred to as a “document pullout operation”.

When the registration sensor 65 detects the leading end of the original document MS, the conveyance speed of the original document MS is gradually decreased through the given conveyance distance. Then, the rotations of the pullout drive roller 86 and the intermediate roller pair 66 are stopped due to the stop of a sheet conveyance motor 192 (see FIG. 6), and the rotation of the scan entrance roller pair is stopped due to the stop of the document reading motor 77. Due to this action, the conveyance of the original document MS is temporarily stopped at the registration position before the first reading and conveying part E. Further, a registration stop signal is sent to the scanner controller 903.

In the present embodiment, for example, the document separating and feeding part B, the registration part C, the document turning part D, the first reading and conveying part E, the second reading and conveying part F, the document ejecting part G, and the document stacking part H function as a conveying part that conveys a document from the document loading tray 53.

In the present embodiment, any one of the first fixed reading unit 151 and the second fixed reading unit 95 functions as a reading unit that reads an image represented on a document while being conveyed by the above-described configuration functioning as a conveying part.

In addition, the ADF 51 is provided with a sound collecting microphone 200. A sound signal indicating a sound collected by the sound collecting microphone 200 is transmitted to the ADF controller 904 of the ADF 51. The sound collecting microphone 200 can measure noise around the ADF 51, and the sound signal collected by the sound collecting microphone 200 is converted into pulse code modulation (PCM) data by an analog to digital (AD) converter in the ADF controller 904 and stored in a random access memory (RAM) 904C. The arrangement of the sound collecting microphone 200 illustrated in FIG. 4 is an example, and may be provided at any place as long as noise around the ADF 51 can be measured.

### System Configuration

FIG. 6 is a diagram illustrating a configuration example of the copier 100 according to the first embodiment.

The copier 100 includes, for example, the image forming apparatus 1 and the ADF 51 attached to the image forming apparatus 1. The copier 100 is communicably connected to a designing personal computer (PC) 909.

The ADF 51 is an example of a document processing apparatus that is attached to an image forming apparatus and includes an autonomous sheet feeding conveyance mode in which a sheet feeding conveyance operation is autonomously performed without an instruction from the image forming apparatus.

### Configuration of Image Forming Apparatus

In the example of FIG. 6, the image forming apparatus 1 includes, for example, the apparatus controller 901, the operation unit 902, the scanner controller 903, the display 905, and an external communication I/F 907. The apparatus controller 901 has a configuration of a computer including, for example, a central processing unit (CPU) 901A, a read only memory (ROM) 901B, and a random access memory (RAM) 901C.

The operation unit 902 is an input device such as a touch panel or an operation button that receives a user's operation. The display 905 is a display device such as a display that displays a display screen such as an operation screen or a setting screen. The external communication I/F 907 is a communication device used to communicate with an external apparatus such as a cloud server.

### Configuration of ADF

FIG. 6 is a block diagram illustrating a part of an electric circuit of the ADF 51 (document processing apparatus).

In the example of FIG. 6, the ADF 51 includes, for example, the ADF controller 904, the second fixed reading unit 95, the document contact sensor 72, the document width sensor 73, the reading entrance sensor 67, the registration sensor 65, the document set sensor 63, a document ejection sensor 61, the first length sensor 57, the second length sensor 58, the third length sensor 202, and the fourth length sensor 201, the sheet feed motor 76, the document reading motor 77, the sheet conveyance motor 192, a pullout clutch 193, a sheet ejection clutch 194, a designing communication I/F 195, and the sound collecting microphone 200.

The ADF controller 904 has, for example, a configuration of a computer including a CPU 904A, a ROM 904B, and a RAM 904C. Preferably, the ADF controller 904 further includes a storage device. The designing communication I/F 195 is a communication device used to communicate with the designing PC 909.

The apparatus controller 901 and the scanner controller 903, and the scanner controller 903 and the ADF controller 904 are communicably connected to each other, respectively. The ADF controller 904 and the apparatus controller 901 are communicably connected to each other via a communication I/F 910. The second fixed reading unit 95 and the apparatus controller 901 are communicably connected to each other via a communication I/F 911.

The sheet conveyance motor 192 connected to the ADF controller 904 is a rotation drive source of the pullout drive roller 86 and the document ejection roller pair 94 of the ADF 51. Further, the pullout clutch 193 connected to the ADF controller 904 connects and disconnects the rotation driving force of the sheet conveyance motor 192 to and from the pullout drive roller 86. Further, the sheet ejection clutch 194 connects and disconnects the rotation drive force of the sheet conveyance motor 192 to and from the document ejection roller pair 94 as a feeding and conveying device.

After receiving the registration stop signal from the ADF controller 904, the scanner controller 903 sends the reading start signal as a sheet feed permission signal to the ADF controller 904. After receiving the reading start signal as a sheet feed permission signal, the ADF controller 904 restarts the rotations of the sheet conveyance motor 192 and the document reading motor 77. Then, at the timing when the leading end of the original document MS calculated based on the pulse count of the document reading motor 77 reaches the reading position by the first fixed reading unit 151 (see FIG. 5), the ADF controller 904 transmits a gate signal indicating the sub-scanning direction effective image area of the first face of the original document MS to the scanner controller 903. The transmission is continued until the trailing end of the original document MS comes out of the reading position by the first fixed reading unit 151, and the first face of the original document MS is read by the first fixed reading unit 151.

The original document MS that has passed through the first reading and conveying part E passes through the scan exit roller pair 92. Then, the leading end of the original document MS is detected by the document ejection sensor 61. When the single-sided reading mode is set, the second face of the original document MS is not to be read by the second fixed reading unit 95. Then, when the leading end of the original document MS is detected by the document ejection sensor 61, the sheet ejection clutch 194 connects the driving force of the sheet conveyance motor 192 to the document ejection roller pair 94. The timing at which the trailing end of the original document MS passes through the nip region of the document ejection roller pair 94 is calculated based on the pulse count of the sheet conveyance motor after the detection of the leading end of the original document MS by the document ejection sensor 61. Then, based on this calculation result, the sheet ejection clutch 194 is stopped.

On the other hand, in a case where the double-sided reading mode is set, the timing from when the leading end of the original document MS is detected by the document ejection sensor 61 to when the original document MS reaches the second fixed reading unit 95 is calculated based on the pulse count of the document reading motor 77. Then, at the timing at which the calculation result is obtained, the ADF controller 904 sends a gate signal indicating the effective image area of the second face of the original document MS in the sub-scanning direction, to the scanner controller 903. The transmission is continued until the trailing end of the original document MS comes out of the reading position by the second fixed reading unit 95, and the second face of the original document MS is read by the second fixed reading unit 95.

The second fixed reading unit 95 includes a contact image sensor (CIS), and the reading surface is subjected to coating processing for the purpose of preventing reading vertical streaks due to adhesion of pasty foreign matter adhering to the original document MS to the reading surface. A second reading roller 96 as a document support unit that supports the original document MS from a non-reading surface side is disposed at a position facing the second fixed reading unit 95. The second reading roller 96 has a role of preventing the original document MS from being lifted at the reading position by the second fixed reading unit 95 and functioning as a reference white portion for acquiring shading data in the second fixed reading unit 95.

### Description of Determination in Consideration of Noise Value, Acoustic Comfort Index, and Productivity

Typically, there has been a technique of changing an operation mode in order to reduce a noise value (decibels) according to a surrounding environment in an apparatus such as a copier. However, a decrease in reading productivity more than necessary has not been considered when the operation mode is changed.

For this reason, in the ADF 51 according to the present embodiment, the document reading control is performed in consideration of the reduction of the noise value (decibels) and the prevention or reduction of the excessive decrease in productivity.

Furthermore, typically, how sound generated by an apparatus such as a copier is felt by a person has not been considered. For example, even when the sound has the same noise value (decibels), the degree of discomfort given to a person is different between a rhythmic sound and a discord.

For this reason, in the ADF 51 according to the present embodiment, the document reading control is performed in consideration of the acoustic comfort index of the sound generated by the ADF 51 in addition to the reduction of the noise value (decibels) and the prevention or reduction of the excessive decrease in productivity.

For this reason, the ADF controller 904 of the ADF 51 performs determination based on the noise value, the acoustic comfort index, and the productivity when the ADF 51 reads the original document MS. In the present embodiment, a trained model 1100 is used to determine the noise value, acoustic comfort index, and productivity. In the present embodiment, the trained model 1100 is stored in the ROM 904B of the ADF controller 904. Then, the CPU 904A of the ADF controller 904 develops the trained model 1100 in, for example, the RAM 904C and uses the model for processing. The trained model 1100 is a model machine-learned by using training data in which document processing information is input data, and the noise value, acoustic comfort index, and productivity (the number of documents processed per a given period of time) are output data.

In other words, the trained model 1100 estimates the noise value due to the sound generated by the ADF 51, the acoustic comfort index of the sound generated by the ADF 51, and the productivity of the ADF 51 when the ADF 51 processes a document according to the document processing information.

The document processing information includes at least one of a setting for the conveying part (for example, the document separating and feeding part B, the registration part C, the document turning part D, the first reading and conveying part E, the second reading and conveying part F, the document ejecting part G, and the document stacking part H) to convey a document and a setting for the reading unit (for example, any one of the first fixed reading unit 151 and the second fixed reading unit 95) to read a document. The document processing information according to the present embodiment further includes information of a document stacked on the document loading tray 53.

The document processing information includes, for example, information such as reading settings (single side or double sides), a sheet feeding speed, a first contact amount, a pullout speed, a second contact amount, a document interval time, and whether or not the pullout driven roller is stopped at the time of the second contact. Further, the document processing information includes, for example, a document size, a sheet type, and a sheet thickness as document information. Among the document processing information, the document processing information that does not affect the reading function and can be changed includes, for example, a sheet feeding speed, a first contact amount, a pullout speed, a second contact amount, a document interval time, and whether or not the pullout driven roller is stopped at the time of the second contact.

The sheet feeding speed is the maximum speed during conveyance from the start of separation and feeding until the leading end of the document reaches the pullout driven roller 87. The pullout speed is the maximum speed at the time of conveyance until the leading end of the document reaches the scan entrance roller pair (89, 90) from the pullout driven roller 87. The first contact amount is a contact amount of the document against the pullout driven roller 87, and the second contact amount is a contact amount of the document against the scan entrance roller pair (89, 90). The document interval time is a time from when the trailing end of one document in the continuously conveyed state passes through the first fixed reading unit 151 to when the leading end of the subsequent document reaches the first fixed reading unit 151.

Whether or not the pullout driven roller is stopped at the time of the second contact indicates whether the contact is performed in a state where the pullout driven roller is completely stopped at the time of the second contact (with stop) or whether the contact is performed while the pullout driven roller is rotating at the reading speed (without stop).

The document processing information according to the present embodiment illustrates an example including information (for example, the document size, the sheet type, and the sheet thickness) of a document stacked on the document loading tray 53 in addition to the setting when the document is conveyed and the setting for reading the document. However, the document processing information is not limited to a mode including the information of the document stacked on the document loading tray 53, and may not include the information of the document stacked on the document loading tray 53. The document processing information described above is an example of a setting for conveying a document and a setting for reading a document, and may be a setting related to conveyance or reading of a document.

The noise value due to the sound generated by the ADF 51 is, for example, the magnitude of the sound generated when the document is conveyed by the conveying part or read by the reading unit, and is expressed in decibels [dB].

The acoustic comfort index is an index indicating, for example, the comfort that a person feels in a sound when the person hears the sound. For example, it is considered that in a case where a sound waveform due to an operation of the ADF 51 has regularity, in other words, a rhythmic sound is generated, the acoustic comfort index is high, and in a case where discord, for example, is generated by a plurality of sounds generated from a plurality of configurations of the ADF 51, the acoustic comfort index is low. Furthermore, it is considered that in a case where a large sound suddenly resonates, the acoustic comfort index is also lowered.

In the present embodiment, the acoustic comfort index is indicated by a numerical value of 1 to 10. In other words, the acoustic comfort index “1” is the most uncomfortable sound, the higher the numerical value of the acoustic comfort index is, the more comfortable the sound is, and the acoustic comfort index “10” is the most comfortable sound. The present embodiment illustrates a case where a numerical value is used as an example of information indicating acoustic comfort index, and is not limited to a mode in which acoustic comfort index is indicated by a numerical value.

The acoustic comfort index used for the training data of the trained model 1100 is set on the basis of an evaluation result by a user who has actually listened to the sound.

The productivity indicates the number of read sheets that can be processed (the number of processable sheets) per a given period of time (for example, one minute).

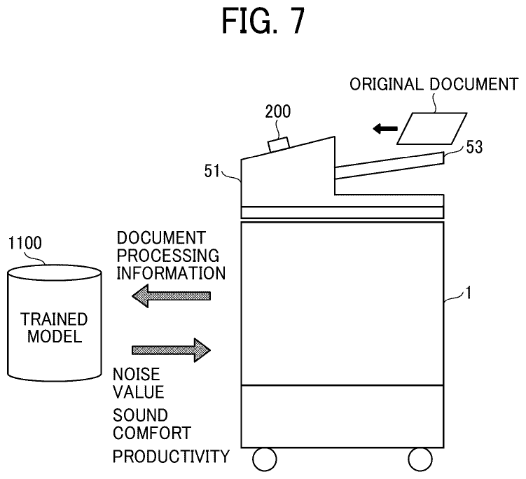

FIG. 7 is a diagram illustrating estimation of noise, acoustic comfort index, and productivity by the trained model 1100 according to the present embodiment.

The ADF 51 according to the present embodiment estimates noise, acoustic comfort index, and productivity by the trained model 1100 when reading a document stacked on the document loading tray 53. For example, the ADF controller 904 of the ADF 51 supplies the document processing information set in the image forming apparatus 1 to the trained model 1100 as input data, and receives the noise value, the acoustic comfort index, and the productivity as output data from the trained model 1100.

The ADF controller 904 of the ADF 51 determines whether the noise value received from the trained model 1100 is smaller than the reference value and whether the acoustic comfort index satisfies a given reference.

When it is determined that the noise value is greater than or equal to a reference value or the acoustic comfort index is less than or equal to a reference, the setting is changed so that the noise value is smaller than the reference value and the acoustic comfort index satisfies the reference. Then, the ADF controller 904 changes the setting so as to increase the productivity after the noise value is smaller than the reference value and the acoustic comfort index satisfies the reference.

For example, there is a method in which the ADF controller 904 changes the setting to a setting with the highest productivity among the settings in which the noise value is smaller than the reference value and the acoustic comfort index satisfies the reference. The ADF controller 904 may automatically change the setting, or may change the setting when receiving a change command from the user.

The present embodiment is not limited to the method of determining the noise value and the productivity, and for example, a method of determining whether or not only the noise value is smaller than a given reference value may be used.

### Functional Configuration

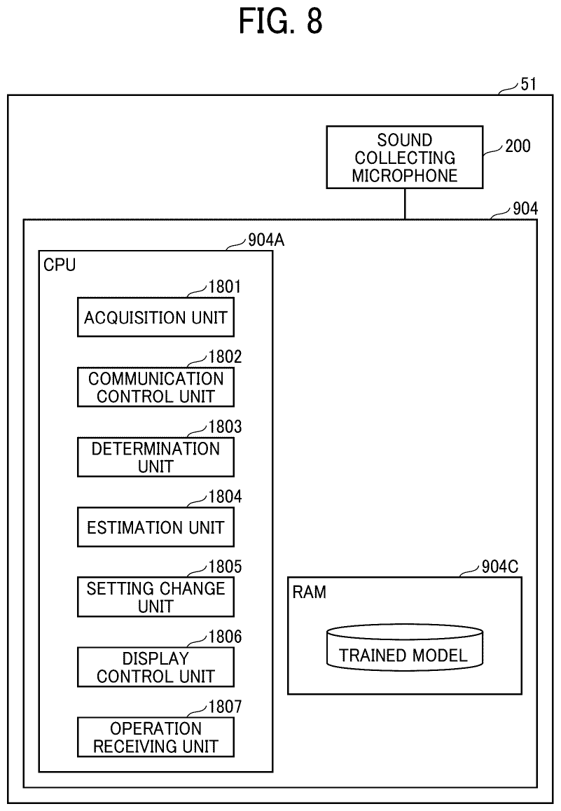

FIG. 8 is a diagram illustrating an example of a functional configuration of a document processing system according to the first embodiment.

As an example, the document processing system is implemented by the ADF (document processing apparatus) 51. In the example of FIG. 8, in the ADF 51, the CPU 904A executes a program stored in the ROM 904B to implement an acquisition unit 1801, a communication control unit 1802, a determination unit 1803, an estimation unit 1804, a setting change unit 1805, a display control unit 1806, and an operation receiving unit 1807. The trained model 1100 is stored in the RAM 904C of the ADF 51.

The acquisition unit 1801 acquires detection results of various sensors. For example, the acquisition unit 1801 acquires the noise value indicating the magnitude of the sound from the sound collecting microphone 200. The noise value includes, for example, a noise value in the surrounding environment of the image forming apparatus 1.

The acquisition unit 1801 also receives document processing information from the image forming apparatus 1. Further, the acquisition unit 1801 acquires image forming apparatus information from the image forming apparatus 1.

The image forming apparatus information is information indicating a current situation for confirming, for example, sound generated by the image forming apparatus 1, and includes, for example, whether or not the image forming apparatus 1 is operating, or a current operation mode set in the image forming apparatus 1.

The communication control unit 1802 transmits or receives information to or from various devices. The communication control unit 1802 executes, for example, a process of transmitting or receiving information to or from the designing PC 909 connected via the designing communication I/F 195.

The determination unit 1803 determines whether the surrounding environment is sufficiently quiet that the ADF 51 should take the noise value and the acoustic comfort index into consideration. For example, in a case where the determination unit 1803 determines that the surrounding environment is quiet, the ADF 51 is controlled to emit a sound having a noise value smaller than the reference value and having high acoustic comfort index. In a case where the surrounding environment is noisy, it is estimated that the sound emitted by the ADF 51 is to be drowned out, and thus, the ADF 51 performs processing without considering the noise value (magnitude of the sound) and the acoustic comfort index. A specific determination content will be described below.

In a case where it is determined that the surrounding environment is sufficiently quiet that the ADF 51 should take the noise value (magnitude of the sound) and the acoustic comfort index into consideration, the estimation unit 1804 estimates the noise value and the acoustic comfort index of the sound emitted by the ADF 51 when the ADF 51 conveys or reads the document on the basis of the document processing information. Furthermore, the estimation unit 1804 according to the present embodiment also estimates the number of documents that can be processed (the number of processable sheets) per a given period of time (for example, one minute), in other words, the productivity. As a specific example, when the document processing information is input to the trained model 1100, the estimation unit 1804 receives the estimation results of the noise value, the acoustic comfort index, and the productivity from the trained model 1100.

When the estimation unit 1804 estimates that the noise value or the acoustic comfort index based on the document processing information is lower than the reference, the setting change unit 1805 changes the setting so that the noise value is smaller or the acoustic comfort index is higher. A specific processing procedure will be described below.

The display control unit 1806 performs control to display information on the display 905 of the image forming apparatus 1. For example, the display control unit 1806 performs control to transmit information desired to be displayed to the image forming apparatus 1 via the communication I/F 910.

The operation receiving unit 1807 receives an operation related to the ADF 51 input to the operation unit 902. For example, the operation receiving unit 1807 receives an operation related to an operation mode of the ADF 51.

The functional configuration of the document processing system illustrated in FIG. 8 is an example. For example, at least a part of each functional configuration included in the ADF 51 illustrated in FIG. 8 may be included in the image forming apparatus 1, the designing PC 909, or an external apparatus (for example, a cloud server).

### Process Flow

A description is given of a process flow of the document processing method performed by the ADF 51 according to the present embodiment.

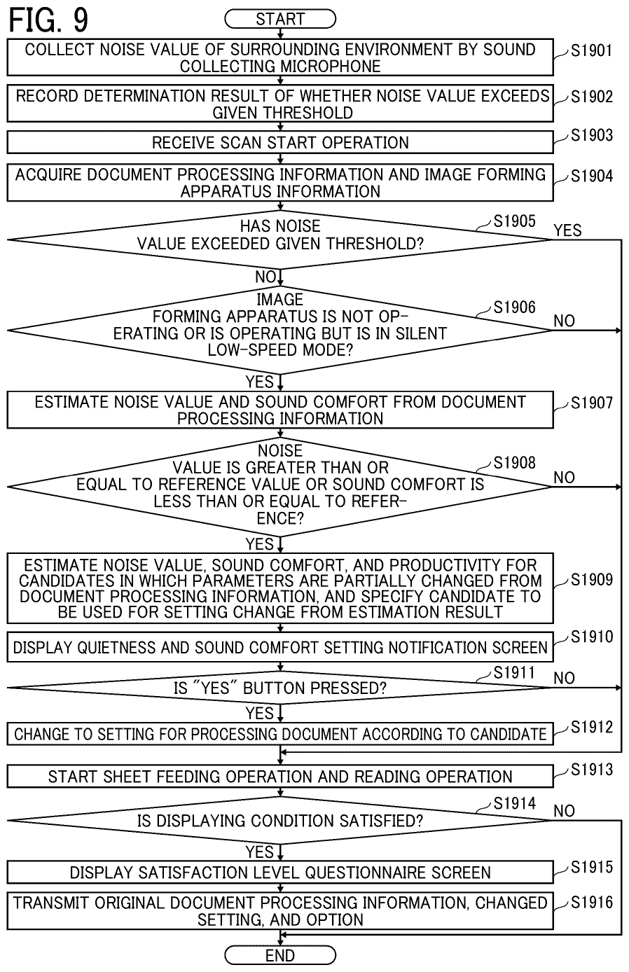

FIG. 9 is a flowchart illustrating a procedure of document processing in the ADF controller 904 of the ADF 51 according to the first embodiment.

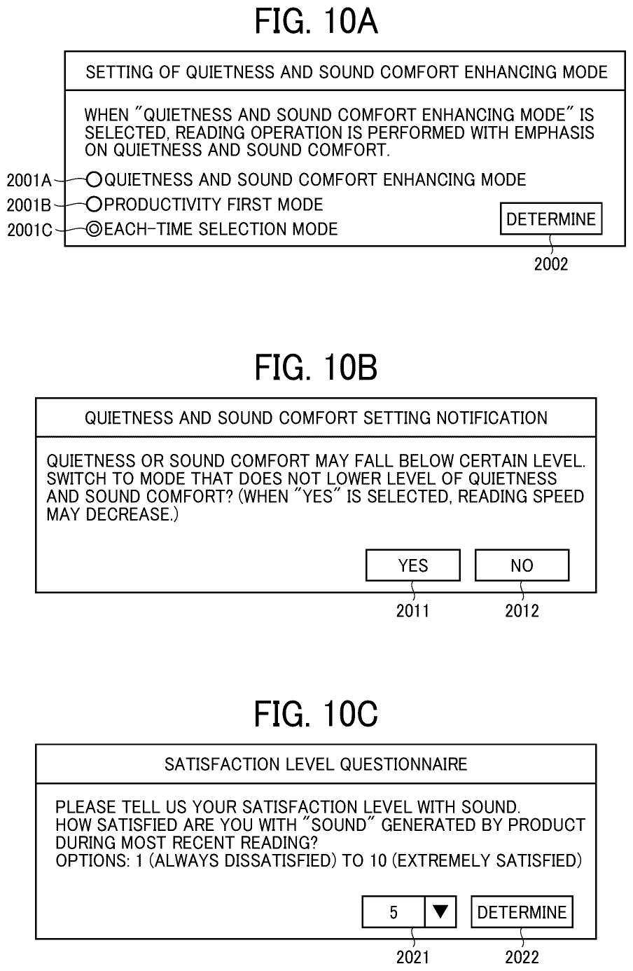

FIGS. 10A, 10B and 10C are diagrams illustrating an example of a screen related to document processing of the ADF 51 according to the first embodiment.

FIG. 10A is an example of a quietness and acoustic comfort index enhancing mode setting screen included in the setting screen of the ADF 51 displayed by the display control unit 1806.

On the quietness and acoustic comfort index enhancing mode setting screen illustrated in FIG. 10A, a radio button 2001A to select a quietness and acoustic comfort index enhancing mode, a radio button 2001B to select a productivity first mode, a radio button 2001C to select an each-time selection mode in which a mode is selected for each document processing, and a determination button 2002 are illustrated. Then, when receiving the selection of the radio button 2001A, the radio button 2001B, or the radio button 2001C via the operation unit 902 and then receiving the pressing of the determination button 2002, the operation receiving unit 1807 causes the ADF controller 904 to proceed with processing in accordance with the selected mode during document processing.

When the operation receiving unit 1807 receives selection of the radio button 2001A (quietness and acoustic comfort index enhancing mode), the ADF controller 904 does not display the screen by the process of step S1910 of FIG. 9 when performing the process illustrated in FIG. 9, and automatically performs the process in a case of “YES” in a branch process of step S1911 of FIG. 9. In a case where the operation receiving unit 1807 receives selection of the radio button 2001B (productivity first mode), the ADF controller 904 does not display the screen by the process of step S1910 of FIG. 9 when performing the process illustrated in FIG. 9, and automatically performs the process in a case of “NO” in the branch process of step S1911 of FIG. 9. When the operation receiving unit 1807 receives selection of the radio button 2001C (the each-time selection mode), the ADF controller 904 performs processing according to the procedure illustrated in FIG. 9.

An example in which the operation receiving unit 1807 according to the present embodiment receives selection of the radio button as an operation related to setting change has been described. However, the present embodiment is not limited to the mode of receiving the selection of the radio button, and may be any aspect as long as the operation receiving unit 1807 can receive approval, for example, related to setting change.

Returning to FIG. 9, the acquisition unit 1801 collects (acquires) the noise value of the surrounding environment from the sound collecting microphone 200 (step S1901). The timing of collecting the noise value in the surrounding environment is set to a time at which the operations of all the drive mechanisms of the image forming apparatus 1 and the ADF 51 are stopped so as not to collect the operation sounds of the image forming apparatus 1 and the ADF 51.

The determination unit 1803 determines whether the collected noise value exceeds a given threshold, and records the determination result in the ROM 904B (step S1902).

Then, the operation receiving unit 1807 receives a scan start operation from the operation unit 902 (step S1903).

The acquisition unit 1801 acquires document processing information and image forming apparatus information from the image forming apparatus 1 (step S1904). The document processing information indicates settings for processing a document according to the start of scanning. The image forming apparatus information includes whether or not the image forming apparatus 1 is currently operating, and an operation mode set in the image forming apparatus 1.

Then, the determination unit 1803 determines whether the noise value of the surrounding environment exceeds a given threshold in the determination result recorded in the ROM 904B (step S1905). When the determination unit 1803 determines that the noise value in the surrounding environment exceeds the given threshold (YES in step S1905), the ADF controller 904 determines that the quietness and the acoustic comfort index of the ADF 51 may not be considered because the noise in the surrounding environment is large, in other words, it is not to change the setting for the conveying part to convey the document (without estimating the noise value and the acoustic comfort index), and starts the sheet feeding operation and the reading operation of the ADF 51 based on the document processing information (step S1913). For this reason, the ADF controller 904 can implement maintenance of productivity.

On the other hand, when the determination unit 1803 determines that the noise value in the surrounding environment does not exceed the given threshold in the determination result recorded in the ROM 904B (NO in step S1905), the determination unit 1803 determines whether the image forming apparatus 1 is not operating or is operating but is in a silent low-speed mode on the basis of the image forming apparatus information (step S1906). In a case where the determination unit 1803 determines that the image forming apparatus 1 is operating and is not in the silent low-speed mode (NO in step S1906), the ADF controller 904 determines that surrounding people are less likely to feel quietness and acoustic comfort index, even when the ADF 51 enhances quietness and acoustic comfort index, due to the operation sound generated from the image forming apparatus 1, and starts the sheet feeding operation and the reading operation of the ADF 51 based on the document processing information (step S1913). The enhancement in quietness indicates a reduction in noise value.

On the other hand, when the determination unit 1803 determines that the image forming apparatus 1 is not operating, or that the image forming apparatus 1 is operating but is in the silent low-speed mode (YES in step S1906), the estimation unit 1804 assumes that the quietness and the acoustic comfort index of the ADF 51 are emphasized because of the relatively quiet surrounding environment, and estimates the noise value and the acoustic comfort index of the sound emitted by the ADF 51 from the document processing information (step S1907). For example, by inputting the document processing information to the trained model 1100, the estimation unit 1804 receives, from the trained model 1100, information indicating the noise value, the acoustic comfort index, and the productivity due to the sound emitted by the ADF 51.

Then, the estimation unit 1804 determines whether or not the received noise value is greater than or equal to the reference value or the acoustic comfort index is less than or equal to the (given) reference (step S1908). When the estimation unit 1804 determines that the noise value is smaller than the reference value and the acoustic comfort index is higher than the reference (NO in step S1908), the ADF controller 904 starts the sheet feeding operation and the reading operation of the ADF 51 based on the document processing information (step S1913).

On the other hand, when the estimation unit 1804 determines that the noise value is greater than or equal to the reference value or that the acoustic comfort index is less than or equal to the reference (YES in step S1908), the estimation unit 1804 generates, from the document processing information, a plurality of candidates of the document processing information in which parameters that do not affect the reading function are partially changed, estimates the noise value, the acoustic comfort index, and the productivity for each of the plurality of candidates of the document processing information, and specifies a candidate to be used for setting change from the estimation result (step S1909). Specifically, the estimation unit 1804 specifies the candidate of the setting with the highest productivity among the candidates having the noise value smaller than the reference value and the acoustic comfort index higher than the reference. The estimation unit 1804 can receive the noise value, the acoustic comfort index, and the productivity for each candidate by inputting to the trained model 1100, from the document processing information, a plurality of candidates of the document processing information in which parameters that do not affect the reading function are changed. Then, a determination method regarding the noise value, the acoustic comfort index, and the productivity will be described.

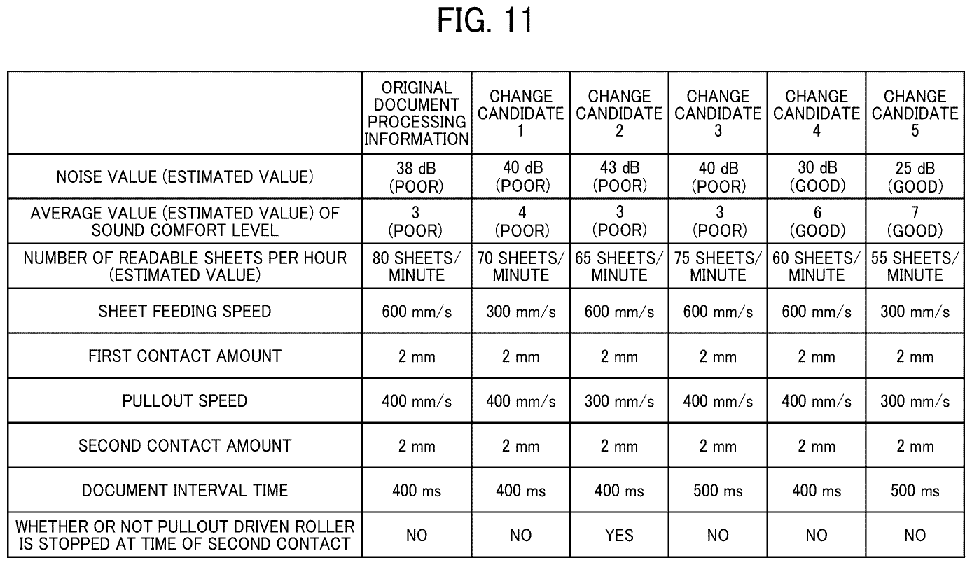

FIG. 11 is an explanatory diagram illustrating estimation of the noise value, acoustic comfort index, and productivity for each document processing information by the estimation unit 1804 according to the present embodiment.

The example illustrated in FIG. 11 illustrates an example in which change candidates 1 to 5 of the document processing information are generated by varying the sheet feeding speed, the first contact amount, the pullout speed, the second contact amount, the document interval time, and whether or not the pullout driven roller is stopped at the time of the second contact, which do not affect the reading function, among the document processing information.

In the example illustrated in FIG. 11, “noise value (estimated value)” is a value estimated as a noise value [dB] emitted by the ADF 51, and is an example of a parameter indicating quietness.

The “average value (estimated value) of acoustic comfort index level” is an example of a parameter indicating the acoustic comfort index. The average value (estimated value) of acoustic comfort index level is a value estimated as an average value of the acoustic comfort index when a plurality of people listen to the sound.

In the present embodiment, as a method of evaluating the acoustic comfort index, an example of determining whether or not the acoustic comfort index is less than or equal to the reference by using the “average value (estimated value) of acoustic comfort index level” will be described. However, the parameter used for the determination of the acoustic comfort index is not limited to the “average value (estimated value) of acoustic comfort index level”, and for example, “standard deviation (estimated value) of acoustic comfort index level” indicating variations in the acoustic comfort index when a plurality of people listen to the sound may be used, or other parameters such as the total value of acoustic comfort index levels may be used.

In the present embodiment, “number of readable sheets per hour (estimated value)” is used as an example of a parameter indicating the productivity.

The determination reference of “noise value (estimated value)” is whether or not it is smaller than a reference value “32 [dB]”. In other words, when a “noise value (estimated value)” is smaller than the reference value “32 [dB]”, the estimation unit 1804 determines that the “noise value (estimated value)” satisfies the reference.

The determination reference of “average value (estimated value) of acoustic comfort index level” is whether or not it is larger than a reference value “5.5” for averaging. In other words, when the “average value (estimated value) of acoustic comfort index level” is larger than the reference value “5.5” for averaging, the estimation unit 1804 determines that the acoustic comfort index is higher than the reference.

In the example illustrated in FIG. 11, in the original document processing information, “noise value (estimated value)” is “38 [dB]”, and the “average value (estimated value) of acoustic comfort index level” is “3”. For this reason, the estimation unit 1804 estimates that the “noise value (estimated value)” is larger than the reference value and the “average value (estimated value) of acoustic comfort index level” is lower than the reference of acoustic comfort index.

Furthermore, in the example illustrated in FIG. 11, whether or not the noise value or the acoustic comfort index satisfies the condition is indicated by “Yes” or “No” in parentheses.

Then, the estimation unit 1804 estimates “noise value (estimated value)”, “average value (estimated value) of acoustic comfort index level”, and “number of readable sheets per hour (estimated value)” for each of the change candidates 1 to 5 of the document processing information in which the parameters that do not affect the reading function are changed.

The change candidates 1 to 5 are automatically generated by changing the parameters that do not affect the reading function. For this reason, for example, the noise value and the acoustic comfort index are not measured.

However, the estimation unit 1804 according to the present embodiment can also estimate, by using the trained model 1100, the noise value, the acoustic comfort index, and the productivity for each of the change candidates 1 to 5 which are automatically generated.

The estimation unit 1804 according to the present embodiment inputs the document processing information corresponding to each of the change candidates 1 to 5 to the trained model 1100. As a result, the estimation unit 1804 receives “noise value (estimated value)”, “average value (estimated value) of acoustic comfort index level”, and “number of readable sheets per hour (estimated value)” in each of the change candidates 1 to 5 from the trained model 1100.

Then, based on the received estimation result, the estimation unit 1804 specifies a conversion candidate that satisfies the references of the noise value and acoustic comfort index. In the example illustrated in FIG. 11, the estimation unit 1804 specifies a conversion candidate 4 and a conversion candidate 5 as the conversion candidates that satisfy the reference.

Then, the estimation unit 1804 specifies the conversion candidate 4 having a high “number of readable sheets per hour (estimated value)” among the conversion candidates 4 and 5 as a setting to be converted.

Returning to FIG. 9, the display control unit 1806 displays a quietness and acoustic comfort index setting notification screen (step S1910). In other words, the display control unit (an example of an output control unit) 1806 outputs, to the display 905, a notification regarding a change in setting for the conveying part to convey the document.

FIG. 10B is an example of the quietness and acoustic comfort index setting notification screen displayed by the display control unit 1806 in step S1910.

The quietness and acoustic comfort index setting notification screen illustrated in FIG. 10B illustrates a “YES” button 2011 and a “NO” button 2012. The operation receiving unit 1807, via the operation unit 902, changes the determination result of step S1911 in FIG. 9 depending on which of the “YES” button 2011 or the “NO” button 2012 is pressed.

Returning to FIG. 9, the setting change unit 1805 determines whether the operation receiving unit 1807 receives pressing of the “YES” button 2011 (step S1911). When the setting change unit 1805 determines that the “YES” button 2011 is not the pressed button, in other words, the pressing of the “NO” button 2012 has been received (NO in step S1911), the ADF controller 904 assumes that the productivity first mode is selected, and starts the sheet feeding operation and the reading operation of the ADF 51 based on the document processing information (step S1913). Thus, in a case where the user does not care about the sound of the ADF 51 or does not want to lower the productivity, the ADF 51 can be operated without performing the change based on the document processing information. For this reason, the ADF 51 can maintain the productivity.

On the other hand, when the setting change unit 1805 determines that the pressing of the “YES” button 2011 has been received (YES in step S1911), the setting change unit 1805 assumes that the “quietness and acoustic comfort index enhancing mode” is selected, and changes the setting for processing the document according to the specified candidate of the document processing information (step S1912). Thus, the setting change unit 1805 changes the setting for conveying the document by the conveying part on the basis of the estimation results of the noise value, the acoustic comfort index, and the productivity by the estimation unit 1804. In the present embodiment, the estimation result for changing the setting is not limited to the combination of the noise value, the acoustic comfort index, and the productivity. For example, the setting change unit 1805 may change the setting on the basis of the estimation results of the noise value and the productivity without considering the acoustic comfort index.

Then, the ADF controller 904 starts the sheet feeding operation and the reading operation of the ADF 51 based on the changed setting (step S1913).

The display control unit 1806 determines whether a condition for displaying a questionnaire is satisfied (step S1914). The condition for displaying the questionnaire may be determined according to the implementation mode. Examples include changing the setting in step S1912, or satisfying a given probability by lottery among the cases where the setting is changed in step S1912. In a case where the display control unit 1806 determines that the condition for displaying the questionnaire is not satisfied (NO in step S1914), the processing is terminated.

When the display control unit 1806 determines that the condition for displaying the questionnaire is satisfied (YES in step S1914), a satisfaction level questionnaire screen is displayed (step S1915).

FIG. 10C illustrates an example of the satisfaction level questionnaire screen.

The satisfaction level questionnaire screen illustrated in FIG. 10C illustrates a pull-down menu 2021 for selecting options indicating the satisfaction levels of “1” to “10”, and a “DETERMINE” 2022. Then, in a case where the operation receiving unit 1807 receives selection of an option of the satisfaction level from the pull-down menu 2021 via the operation unit 902 and then receives pressing of the “DETERMINE” button 2022, the ADF controller 904 proceeds the processing assuming that the input of the satisfaction level is completed.

Returning to FIG. 9, the communication control unit 1802 associates the original document processing information (an example of the setting before the change), the changed setting, and the selected option of the satisfaction level with each other, transmits the associated information to an external apparatus (for example, the designing PC 909) (step S1916), and terminates the processing. The transmission timing is not limited to the mode of transmitting the associated information every time the questionnaire is performed. For example, the ADF controller 904 may store the number of times of setting change in the ROM 904B, associate the original document processing information, the changed setting, and the selected option of the satisfaction level with each other at an arbitrary timing, and transmit the accumulated data corresponding to the number of times to an external apparatus.

The external apparatus can recognize the change in the noise value and the acoustic comfort index for each environment and setting based on the received information. Then, the external apparatus can acquire training data more suitable for machine learning by performing an evaluation experiment of the noise value and the acoustic comfort index according to the received information. For this reason, the designers, for example, of the ADF 51 can recognize under what conditions the user experienced an increase in noise value or a decrease in acoustic comfort index during actual use. Furthermore, the designers, etc. can acquire efficient training data by performing an evaluation experiment of the noise value and the acoustic comfort index based on the received information. For this reason, the present embodiment can enhance the estimation accuracy of the noise value and the acoustic comfort index using the trained model 1100.

In addition, it is considered that depending on, for example, the industry type or the site of the delivery destination of the copier 100, the sound perceived as pleasant varies, in other words, the acoustic comfort index varies. On the other hand, the copier 100 according to the present embodiment can collect the actual satisfaction level by receiving an input to the satisfaction level questionnaire screen. The external apparatus, for example, can generate the trained model 1100 in consideration of, for example, the industry type or the site of the delivery destination by generating training data in consideration of options, for example, included in the received information and performing additional learning.

As illustrated in the flowchart described above, the setting change unit 1805 changes the setting for conveying the document by the conveying part on the basis of the estimation results of the noise value, the acoustic comfort index, and the productivity by the estimation unit 1804, so that the noise value, the acoustic comfort index, and the productivity can be enhanced.

The processing procedure illustrated in FIG. 9 illustrates an example in which the image forming apparatus 1 is operated in the “quietness and acoustic comfort index enhancing mode” as necessary since it is considered that the sound of the ADF 51 resonates in the case where the image forming apparatus 1 is not operating or is operating but in the silent low-speed mode. However, the ADF controller 904 according to the present embodiment is not limited to the process switching method according to the operation status of the image forming apparatus 1 as illustrated in FIG. 9. As a modification, in a case where the ADF 51 is to be operated in the “quietness and acoustic comfort index enhancing mode”, the ADF controller 904 notifies the image forming apparatus 1 of the operation, and operates the image forming apparatus 1 in the silent low-speed mode.

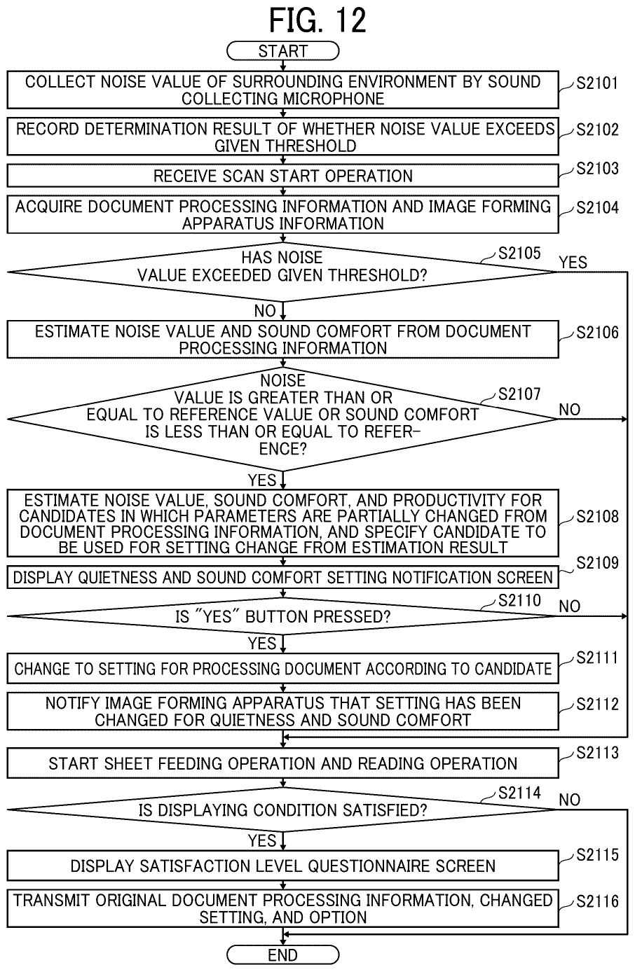

FIG. 12 is a flowchart illustrating a procedure of document processing in the ADF controller 904 of the ADF 51 according to the modification.

The ADF controller 904 performs processes similar to those in steps S1901 to S1905 in the processing procedure illustrated in FIG. 9 (steps S2101 to S2105).

After the processing of step S2105, the ADF controller 904 of the ADF 51 according to the modification does not perform the determination as in step S1906 of FIG. 9, and the estimation unit 1804 estimates the noise value and the acoustic comfort index of the sound emitted by the ADF 51 from the document processing information (step S2106). Specifically, by inputting the document processing information to the trained model 1100, the estimation unit 1804 receives, from the trained model 1100, information indicating the noise value, the acoustic comfort index, and the productivity due to the sound emitted by the ADF 51.

Then, the estimation unit 1804 determines whether or not the received noise value is greater than or equal to the reference value or the acoustic comfort index is less than or equal to the reference (step S2107). When the estimation unit 1804 determines that the noise value is smaller than the reference value and the acoustic comfort index is higher than the reference (NO in step S2107), the ADF controller 904 starts the sheet feeding operation and the reading operation of the ADF 51 based on the document processing information (step S2113).

On the other hand, when the estimation unit 1804 determines that the noise value is greater than or equal to the reference value or that the acoustic comfort index is less than or equal to the reference (NO in step S2107), the processing similar to that in FIG. 9 and steps S1909 to S1910 is performed to display the acoustic comfort index setting notification screen (steps S2108 to S2109). The acoustic comfort index setting notification screen is similar to that illustrated in FIG. 10B.

Then, the setting change unit 1805 determines whether the operation receiving unit 1807 receives the pressing of the “YES” button 2011 (step S2110). When the setting change unit 1805 determines that the “YES” button 2011 is not the pressed button, in other words, the pressing of the “NO” button 2012 has been received (NO in step S2110), the ADF controller 904 assumes that the productivity first mode is selected, and starts the sheet feeding operation and the reading operation of the ADF 51 based on the document processing information (step S2113).

On the other hand, when the setting change unit 1805 determines that the operation receiving unit 1807 has received the pressing of the “YES” button 2011 (YES in step S2110), the setting change unit 1805 assumes that the “quietness and acoustic comfort index enhancing mode” is selected, and changes the setting for processing the document according to the specified candidate of the document processing information (step S2111).

Furthermore, the setting change unit 1805 notifies the image forming apparatus 1 that the setting has been changed for quietness and acoustic comfort index (step S2112). When receiving the notification, the apparatus controller 901 of the image forming apparatus 1 switches the operation mode to the silent low-speed mode. In the case of the low-speed silent mode, the image forming apparatus 1 sets the driving speed of the drive mechanism included in the image forming apparatus 1, for example, the sheet conveyance motor 192, the sheet feed motor 76, and the document reading motor 77 to be lower than that in the normal mode.

In other words, even when the ADF 51 enhances the acoustic comfort index, in a case where the operation sound of the image forming apparatus 1 is large, the person around the copier 100 is less likely to feel the quietness and acoustic comfort index of the ADF 51. For this reason, in the present modification, in a case where the “quietness and acoustic comfort index enhancing mode” is selected in the ADF 51, the apparatus controller 901 controls the operation sound of the image forming apparatus 1 not to be generated. By so doing, discomfort is prevented from being given to a person around the copier 100.

Then, the ADF controller 904 starts a sheet feeding operation and a reading operation of the ADF 51 based on the changed setting (step S2113).

The display control unit 1806 determines whether a condition for displaying a questionnaire is satisfied (step S2114). The condition for displaying the questionnaire may be determined according to the implementation mode. In a case where the display control unit 1806 determines that the condition for displaying the questionnaire is not satisfied (NO in step S2114), the processing is terminated.

When the display control unit 1806 determines that the condition for displaying the questionnaire is satisfied (YES in step S2114), the satisfaction level questionnaire screen is displayed (step S2115). Then, it is assumed that the operation receiving unit 1807 receives an option of the satisfaction level from the satisfaction level questionnaire screen via the operation unit 902.

The communication control unit 1802 associates the original document processing information, the changed setting, and the selected option of the satisfaction level with each other, transmits the associated information to an external apparatus (for example, the designing PC 909) (step S2116), and terminates the processing.

In the present embodiment and the above-described modification, by performing control to enhance the acoustic comfort index of the ADF 51 in a situation where the operation sound of the image forming apparatus 1 is small, the sound with high acoustic comfort index by the ADF 51 can be prevented or reduced from being drowned out by the operation sound of the image forming apparatus 1. For this reason, in the copier 100 according to the present embodiment and the modification, in a situation where the operation sound of the image forming apparatus 1 is small, the ADF 51 is controlled to emit only sound with high acoustic comfort index, and thus, the discomfort to the surrounding people can be prevented or reduced.

Then, generation of the trained model 1100 for determining the noise value, the acoustic comfort index, and the productivity will be described. In the present embodiment, an example in which a training phase and an inference phase are executed by different apparatuses will be described.

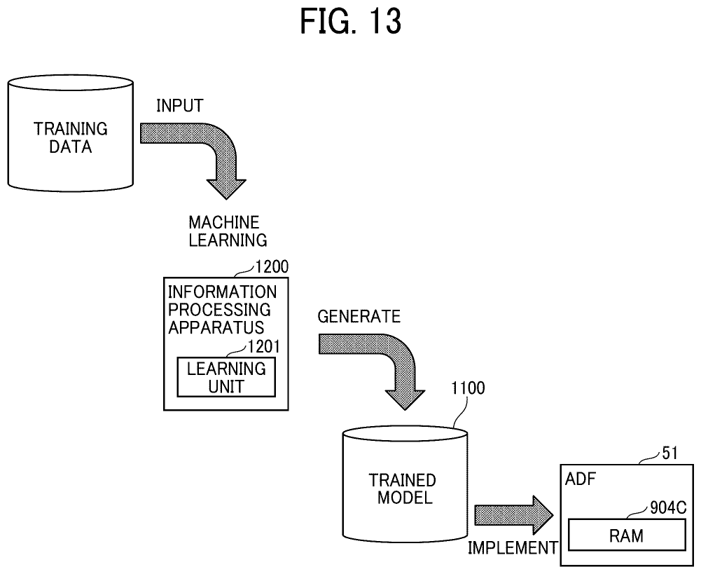

FIG. 13 is an explanatory diagram illustrating a training phase until an information processing apparatus 1200 according to the present embodiment generates the trained model 1100 and implements the trained model 1100 on the ADF 51.

As illustrated in FIG. 13, the trained model 1100 generated by the information processing apparatus 1200 is implemented on the ADF 51. In the present embodiment, as an example, an example in which the training phase and the inference phase are executed by different apparatuses will be described. However, the method is not limited to a method in which the training phase and the inference phase are executed by different apparatuses, and the training phase and the inference phase may be executed by the same apparatus.

The information processing apparatus 1200 is an example of a learned model generation apparatus, and executes the training phase. The information processing apparatus 1200 may be a cloud server, a desktop personal computer (PC), or a portable terminal device such as a smartphone or a tablet terminal.

The information processing apparatus 1200 includes a learning unit 1201. The learning unit 1201 generates the trained model 1100 by performing machine learning based on a training data set. The trained model 1100 is generated by applying supervised learning based on training data to a neural network which is a base.

The training data is information for generating the trained model 1100, and includes a setting for processing a document such as the document processing information, and information indicating the noise value, acoustic comfort index, and productivity when the setting is used. Further, the training data according to the present embodiment also includes document information. In the present embodiment, the accuracy of estimation can be enhanced by including the information described above in the training data. Specific training data will be described below.

As machine learning used for generating the trained model 1100, for example, a neural network is applied. As another example of machine learning, deep learning may be applied through machine learning that uses a deep neural network (DNN). As the deep learning, for example, a convolutional neural network, a recurrent neural network (RNN), or a long-short term memory (LSTM) may be applied.

The ADF 51 according to the present embodiment stores a configuration corresponding to the trained model 1100 generated by the information processing apparatus 1200 in the ROM 904B. The trained model 1100 is a kind of calculation algorithm, and is modularized and stored as a part of a control program of the ADF controller 904 of the ADF 51.

In the example of FIG. 13, a case where the trained model 1100 is stored in the ROM 904B of the ADF 51 is illustrated. However, the trained model 1100 may be implemented on the apparatus controller 901 of the image forming apparatus 1, or may be implemented on an external apparatus such as a cloud server 908, for example.

Then, the training data used to generate the trained model 1100 will be described.

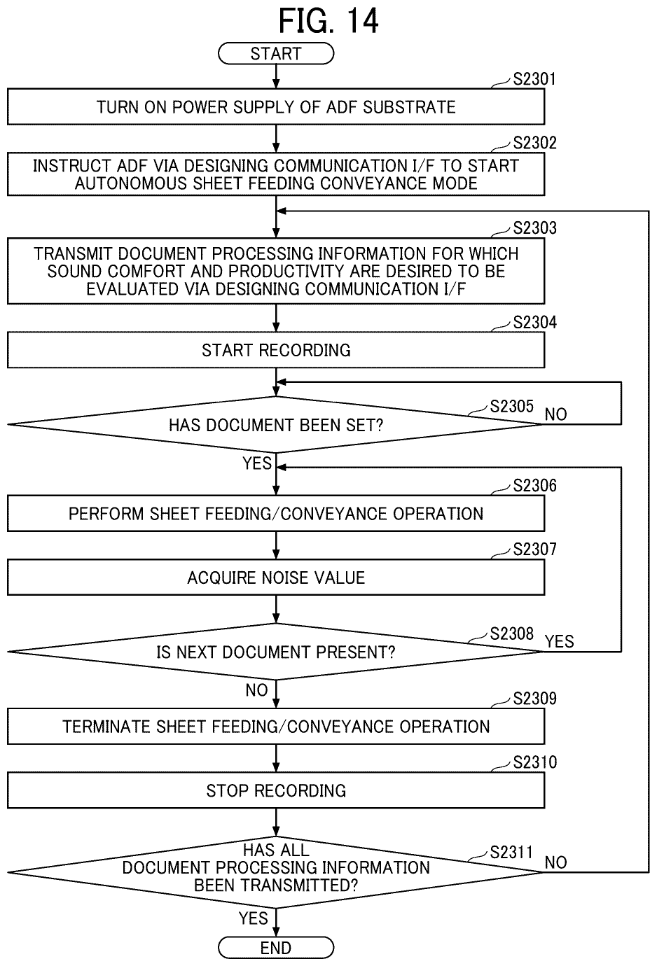

FIG. 14 is a flowchart illustrating a procedure of collecting information for generating the training data according to the present embodiment.

The ADF 51 used to generate the training data may be connected to the image forming apparatus 1 or may be operated alone without being connected to the image forming apparatus 1. In a case where the ADF 51 is operated alone, only the power is to be supplied. For this reason, the user sets in advance such that the power is supplied to the ADF 51 using a stabilization power supply, for example.

Then, the designer (user) performs an operation to turn on the power supply of the ADF 51 substrate (step S2301). When power is supplied, the ADF 51 enters a state of waiting for communication from the image forming apparatus 1.

The designing PC 909 instructs the ADF 51 via the designing communication I/F 195 to start the autonomous sheet feeding conveyance mode according to the operation from the designer (user) (step S2302).

In the case of the autonomous sheet feeding conveyance mode, the ADF 51 is set to automatically start sheet feeding conveyance at a timing when the document set sensor 63 detects that a document is set.

In the present embodiment, the collection process can be facilitated by collecting the information for generating the training data in the autonomous sheet feeding conveyance mode. Furthermore, since the main body of the image forming apparatus 1 is not operated, information for generating training data can be collected without being affected by noise generated from the image forming apparatus 1.

In accordance with an operation from a designer (user), the designing PC 909 transmits document processing information indicating settings for which the noise value, the acoustic comfort index, and the productivity are desired to be evaluated to the ADF 51 via the designing communication I/F 195 (step S2303). Then, the ADF controller 904 of the ADF 51 performs setting in accordance with the received document processing information. The document processing information includes, for example, reading settings (single side or double sides), a sheet feeding speed, a first contact amount, a pullout speed, a second contact amount, a document interval time, and whether or not the pullout driven roller is stopped at the time of the second contact.

In accordance with an instruction from the designing PC 909, the ADF controller 904 of the ADF 51 starts recording with the sound collecting microphone 200 before setting the document (step S2304). The recorded sound data is used to determine the acoustic comfort index of the sound emitted by the ADF 51. It is assumed that a designer (user) stacks a document in the document loading tray 53 of the ADF 51 in advance in order to collect noise.

The ADF controller 904 of the ADF 51 determines whether a document is set in the document loading tray 53 in accordance with a signal from the document set sensor 63 (step S2305). When it is determined that no document is set in the document loading tray 53 (NO in step S2305), the process of step S2305 is repeated until the document is set.

When the ADF controller 904 of the ADF 51 determines that a document is set in the document loading tray 53 (YES in step S2305), a sheet feeding/conveyance operation in the autonomous sheet feeding conveyance mode is performed (step S2306).

The ADF controller 904 of the ADF 51 acquires a noise value (actual measurement data) during the sheet feeding/conveyance operation based on the sound data recorded by the sound collecting microphone 200 while performing the sheet feeding/conveyance operation (step S2307).

The ADF controller 904 of the ADF 51 determines whether a document is present in the document loading tray 53 according to a signal from the document set sensor 63 every time one sheet is fed (step S2308). When the ADF controller 904 of the ADF 51 determines that a document is present in the document loading tray 53 (YES in step S2308), the processing of step S2306 is performed.

When the ADF controller 904 of the ADF 51 determines that no document is present in the document loading tray 53 (NO in step S2308), the ADF controller 904 terminates the sheet feeding/conveyance operation after calculating the productivity (step S2309). The productivity is calculated, for example, by dividing the time from the start to the end of the sheet feeding/conveyance operation by the number of sheets of the document conveyed.

The ADF controller 904 of the ADF 51 stops the recording using the sound collecting microphone 200 (step S2310).

Then, the designing PC 909 determines whether all the document processing information for which the noise value, the acoustic comfort index, and the productivity are desired to be evaluated has been transmitted to the ADF 51 (step S2311). When it is determined that all the document processing information for which the noise value, the acoustic comfort index, and the productivity are desired to be evaluated has not been transmitted to the ADF 51 (NO in step S2311), the processing is performed again from step S2303.

When determining that all the document processing information for which the noise value, the acoustic comfort index, and the productivity are desired to be evaluated has been transmitted to the ADF 51 (YES in step S2311), the designing PC 909 terminates the processing.

By performing the above-described processing, the designing PC 909 according to the present embodiment can acquire, for each document processing information, information indicating the productivity, the noise value in the case of operating according to the document processing information, and the sound data in the case of operating according to the document processing information.

Then, the designing PC 909 makes various people hear the sound data, and collects information indicating a acoustic comfort index level from “1” to “10” from the people via the operation unit, for example. The designing PC 909 calculates the “average value (estimated value) of acoustic comfort index level” based on the acoustic comfort index level input from each of a plurality of persons.

Then, an arbitrary computer such as the designing PC 909 generates training data by associating the noise value, the productivity, and the “average value (estimated value) of acoustic comfort index level” with each document processing information for which the noise value, the acoustic comfort index, and the productivity are desired to be evaluated according to the operation of an operator, for example.

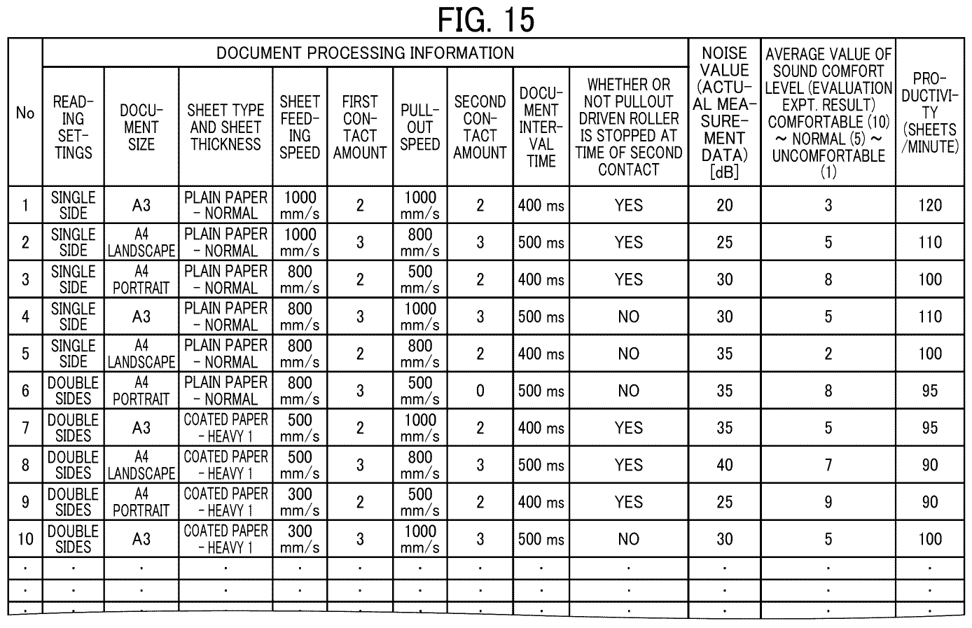

FIG. 15 is a diagram illustrating a structure of the training data according to the present embodiment.

As illustrated in FIG. 15, the training data associates the noise value (actual measurement data), the average value of acoustic comfort index level (evaluation result), and the (reading) productivity with each document processing information. The document processing information includes, similarly to the above-described example, reading settings (single side or double sides), a sheet feeding speed, a first contact amount, a pullout speed, a second contact amount, a document interval time, and whether or not the pullout driven roller is stopped at the time of the second contact. Then, the information processing apparatus 1200 generates a trained model on the basis of the training data.

Further, as illustrated in FIG. 15, the document processing information includes document information such as information on a document size, and a sheet type or sheet thickness, in addition to information on the operation of the ADF 51. In the present embodiment, since the document processing information includes the document information, the estimation accuracy can be enhanced. The present embodiment illustrates an example of the document processing information, and the document information may not be included. In a case where the estimation unit 1804 uses the document information when performing estimation using the trained model 1100, the user may input the document size, and the sheet type or sheet thickness. When the estimation unit 1804 performs estimation, the estimation accuracy of the noise value, the acoustic comfort index, and the productivity can be enhanced by using the document information as the input data.

As described above, the training data includes the document processing information as the input data, and the noise value, the acoustic comfort index (“average value of acoustic comfort index level”), and the productivity as the output data.

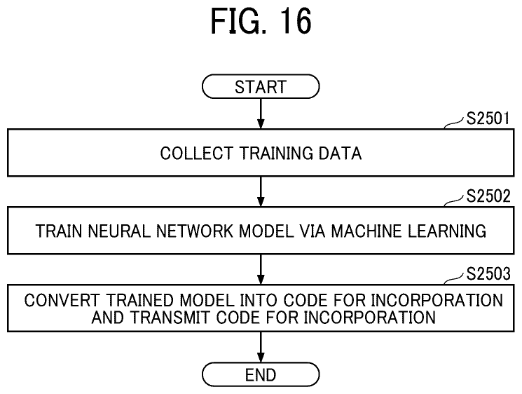

FIG. 16 is a flowchart illustrating a procedure of generating a trained model in the information processing apparatus 1200 according to the present embodiment.

The flowchart illustrated in FIG. 16 illustrates an example of processing up to generation of a trained model by deep learning (DL) using a neural network (NN). The present embodiment is not limited to the example using deep learning (DL), and a deep neural network (DNN) may be used. As the deep learning, for example, a convolutional neural network, a recurrent neural network (RNN), or a long-short term memory (LSTM) may be applied.

The information processing apparatus 1200 collects (acquires) training data generated by, for example, another computer (step S2501).

The information processing apparatus 1200 performs machine learning on the neural network using the collected training data to generate a trained model (step S2502). The trained model can be generated by using a general artificial intelligence (AI) framework. As the AI framework, for example, TensorFlow®, MATLAB®, PyTorch®, or ONNX® can be applied.

The information processing apparatus 1200 converts the trained model generated by machine learning into a code for incorporation into the ADF controller 904 of the ADF 51 and transmits the code for incorporation to the ADF 51 (step S2503). The trained model generated by the AI framework is often not in a format that can be processed (processable) by the CPU 904A of the ADF 51. For this reason, the information processing apparatus 1200 converts the trained model 1100 into the code for incorporation (for example, C language) and outputs the code for incorporation to the ADF controller 904 of the ADF 51. The ADF controller 904 of the ADF 51 stores the trained model 1100 in the ROM 904B based on the received code for incorporation.

Meanwhile, there are innumerable combinations of parameters included in the document processing information. For this reason, when the designer of the ADF 51 performs the conveyance operation under various conditions in the design stage of the ADF 51 and evaluates the noise value and the acoustic comfort index with the sound generated by the conveyance operation, it is likely that man-hours and cost are extremely required, and an insufficiently studied combination occurs.

On the other hand, the ADF controller 904 according to the present embodiment can estimate the noise value, the acoustic comfort index, and the productivity with a certain degree of accuracy even for an unknown combination that is not included in the training data by performing inference using the trained model 1100.

For example, in the document processing information based on a combination of specific parameters included in the training data, an increase or a decrease in the noise value, or an enhancement or a decrease in the acoustic comfort index, which is not assumed by the designer, may occur due to a combination of a plurality of operations. The information processing apparatus 1200 according to the present embodiment performs machine learning on the basis of the training data. For this reason, by using the trained model 1100 on which the machine learning is performed, the ADF controller 904 can estimate an increase or a decrease in the noise value and an enhancement or a decrease in the acoustic comfort index which are not assumed by the designer even when an operation is performed according to the document processing information which is not included in the training data.

As a specific example of the acoustic comfort index, depending on a combination of a plurality of parameters included in the document processing information, the trained model 1100 may be able to predict that a sound at the time of contact on the roller overlaps with a contact sound on another roller. Furthermore, depending on the combination of the plurality of parameters included in the document processing information, it is likely that the trained model 1100 can predict that the sound at the time of contact on the roller is a rhythmic pattern that makes a listener comfortable although not designed by the designer.

In the present embodiment, an example assuming that the information processing apparatus 1200 generates the trained model 1100 and incorporates the generated trained model 1100 into all the ADF 51 to be produced has been described. However, the present embodiment illustrates an example, and as another example, in the assembly process of the ADF 51 in the factory, it is also possible to generate the trained model 1100 from the acquisition of the training data using the ADF 51 for each assembled ADF 51 and incorporate the completed trained model 1100 into the ADF 51. In this case, since the trained model 1100 is optimized for the ADF 51, the accuracy of estimation can be enhanced.

As described above, the ADF controller 904 of the ADF 51 according to the present embodiment can enhance the accuracy of the estimation of the noise value, the acoustic comfort index, and the productivity by using the trained model 1100.

### Second Embodiment

In the embodiment described above, the case where the ADF controller 904 of the ADF 51 executes an estimation phase using the trained model 1100 has been described. However, the configuration for performing the estimation phase is not limited to the controller of the ADF. In a second embodiment, a case where the processing is performed by an image forming apparatus will be described.

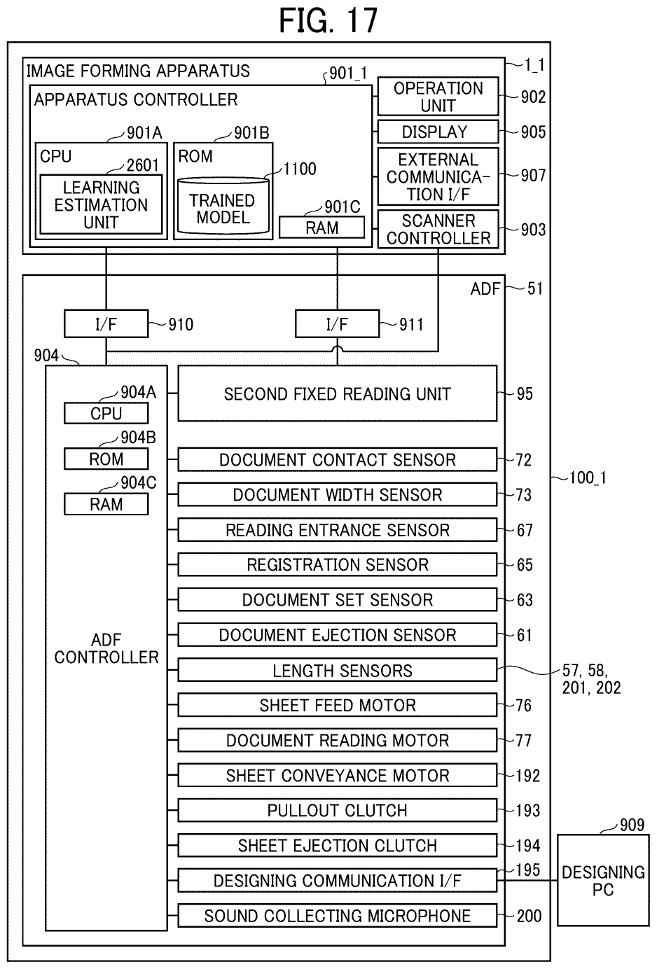

FIG. 17 is a diagram illustrating a configuration example of a copier 100_1 according to the second embodiment.

In the copier 100_1 illustrated in FIG. 17, the same reference signs are assigned to the same configurations as those of the copier 100 of the first embodiment, and the description thereof is omitted.

An apparatus controller 901_1 of an image forming apparatus 1_1 illustrated in FIG. 17 stores the trained model 1100 in the ROM 901B.

Then, the apparatus controller 901_1 of the image forming apparatus 1_1 implements a learning estimation unit 2601 by executing a program stored in the ROM 901B.

The learning estimation unit 2601 implements the estimation phase using the trained model 1100.

Similarly to the above-described embodiment, the ADF controller 904 of the ADF (document processing apparatus) 51 according to the present embodiment implements the acquisition unit 1801, the communication control unit 1802, the determination unit 1803, the estimation unit 1804, the setting change unit 1805, the display control unit 1806, and the operation receiving unit 1807.

However, the estimation unit 1804 of the ADF (document processing apparatus) 51 outputs the document processing information to the apparatus controller 901_1 of the image forming apparatus 1 without performing estimation using the trained model in the ADF 51.

The learning estimation unit 2601 of the apparatus controller 901_1 delivers the input document processing information to the trained model 1100. By so doing, the “noise value (estimated value)”, “average value (estimated value) of acoustic comfort index level”, and “number of readable sheets per hour (estimated value)” are received from the trained model 1100.

Then, the learning estimation unit 2601 outputs the “noise value (estimated value)”, “average value (estimated value) of acoustic comfort index level”, and “number of readable sheets per hour (estimated value)” to the estimation unit 1804 of the ADF (document processing apparatus) 51.

Then, the estimation unit 1804 determines whether or not the input noise value is greater than or equal to the reference value, or the acoustic comfort index is less than or equal to the reference.

When the estimation unit 1804 determines that the noise value is smaller than the reference value and the acoustic comfort index is better than the reference, the ADF controller 904 starts the sheet feeding operation and the reading operation of the ADF 51 based on the document processing information.

When the estimation unit 1804 determines that the noise value is greater than or equal to the reference value or that the acoustic comfort index is less than or equal to the reference, the estimation unit 1804 outputs, to the apparatus controller 901_1 of the image forming apparatus 1_1, a plurality of candidates of the document processing information in which parameters that do not affect the reading function have been partially changed. The learning estimation unit 2601 performs estimation by the trained model 1100 again using the input candidate of the document processing information, and outputs the estimation results to the estimation unit 1804. A description will be omitted below as in the above-described embodiment.

In the present embodiment, the CPU 901A of the image forming apparatus 1_1 is used to execute the estimation phase. Since the CPU 901A of the image forming apparatus 1_1 has higher performance than the CPU 904A of the ADF 51, the processing time of the estimation phase can be shortened. Furthermore, since the performance of the CPU 904A of the ADF 51 can be prevented or reduced, cost reduction can be achieved.

### Third Embodiment

In the above-described embodiment, the case where the configuration in the copier executes the estimation phase using the trained model 1100 has been described. However, the configuration for performing the estimation phase is not limited to the configuration in the copier. In a third embodiment, an example in which an external apparatus capable of communicating with the copier executes the estimation phase will be described.

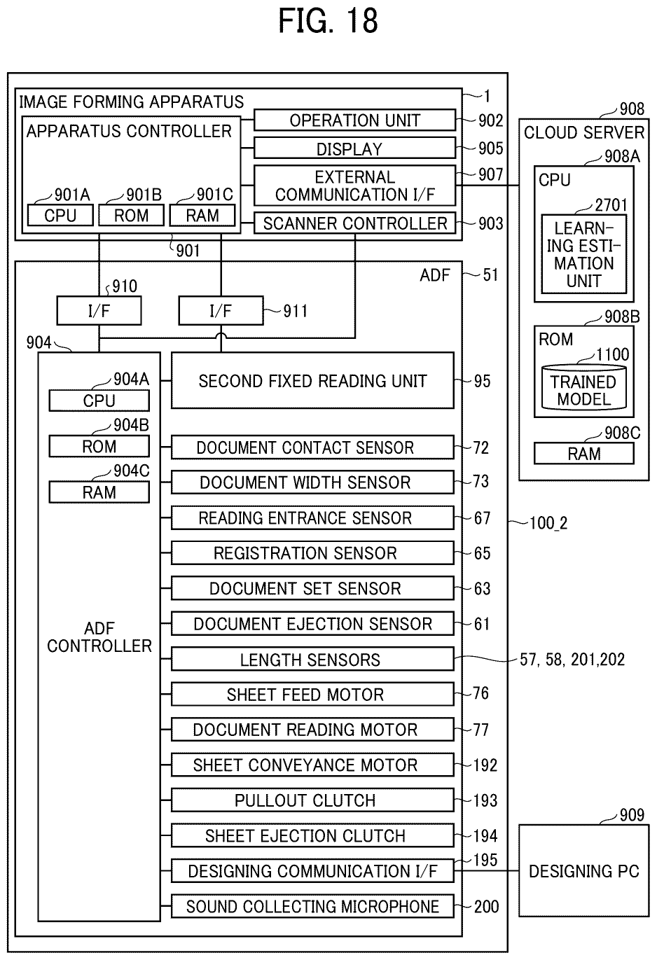

FIG. 18 is a diagram illustrating a configuration example of a copier 100_2 and the cloud server 908 according to the third embodiment.

In the copier 100_2 illustrated in FIG. 18, the same reference signs are assigned to the same configurations as those of the copier 100_1 of the second embodiment, and the description thereof is omitted. In the example illustrated in FIG. 18, the cloud server 908 is provided as an external apparatus capable of communicating with the copier 100_2. In the present embodiment, the apparatus that executes the estimation phase is not limited to a cloud server, and may be any apparatus outside the copier.

The cloud server 908 illustrated in FIG. 18 has a configuration of a computer including, for example, a CPU 908A, a ROM 908B, and a RAM 908C. The cloud server 908 stores the trained model 1100 in the ROM 908B.

Then, the CPU 908A of the cloud server 908 implements a learning estimation unit 2701 by executing a program stored in the ROM 908B.

The learning estimation unit 2701 implements the estimation phase using the trained model 1100.

The estimation unit 1804 of the ADF 51 transmits the document processing information to the cloud server 908 to receive the estimation result by the trained model 1100. As a specific processing procedure, a procedure similar to the procedure of the second embodiment, for example, is used, and the description of the procedure is omitted.

Although FIG. 18 illustrates an example in which one copier 100_2 is connected to the cloud server 908, a plurality of copiers 100_2 may be connected to the cloud server 908. Then, the cloud server 908 estimates the noise value, the acoustic comfort index, and the productivity based on the document processing information transmitted from each of the plurality of copiers 100_2.

The trained model 1100 of the cloud server 908 is machine-learned using training data based on each of the plurality of copiers 100_2 in order to estimate the noise value, the acoustic comfort index, and the productivity of each of the plurality of copiers 100_2.

When the types of the ADF 51 implemented on the plurality of copiers 100_2 are different, the designer acquires sound data for each type of the ADF 51 and prepares training data using the sound data. Then, the information processing apparatus 1200 (see FIG. 13) generates the trained model 1100 by performing machine learning using the training data. For this reason, the trained model 1100 of the cloud server 908 can estimate the noise value, the acoustic comfort index, and the productivity for each of the plurality of copiers 100_2.

Further, similarly to the first embodiment, the information processing apparatus 1200 according to the present embodiment collects, from each of the plurality of copiers 100_2 connectable to the cloud server 908, original document processing information, changed settings, a noise value based on sound data collected by the sound collecting microphone 200, and an option indicating acoustic comfort index input from a user, generates training data on the basis of the collected information, and performs additional learning of the trained model 1100 using the generated training data. In the present embodiment, since the additional learning can be performed on the basis of the information collected from the plurality of copiers 100_2, the estimation accuracy can be enhanced.

Further, the training data according to the present embodiment may include information for identifying the type, for example, of the copier 100_2 or the ADF 51. In this case, the cloud server 908 inputs the document processing information and the information for identifying to the trained model 1100, and receives the noise value, the acoustic comfort index, and the productivity from the trained model 1100.

By the cloud server 908 according to the present embodiment performing the above-described processing, even in a case where various copiers 100_2 are connected to the cloud server 908, estimation of the noise value, the acoustic comfort index, and the productivity corresponding to the copier 100_2 can be implemented.

In addition, in the present embodiment, the performance of the CPU 904A of the ADF 51 and the CPU 901A of the image forming apparatus 1 included in the copier 100_2 can be prevented or reduced, and thus, cost reduction can be achieved.

### Modification

In the embodiment described above, an example has been described in which a device such as the CPU 904A estimates the noise value, the acoustic comfort index, and the productivity from the document processing information using the trained model 1100. However, the above-described embodiment is not limited to estimation using the trained model 1100.

For example, a method may be used in which the processing device stores table information in which the document processing information is associated with the noise value, the acoustic comfort index, and the productivity, and estimates the noise value, the acoustic comfort index, and the productivity on the basis of the document processing information with reference to the correspondence relationship of the table information.

In the embodiments and the modification described above, when the document is conveyed or read by the ADF, at least the noise value due to the sound generated in the conveyance or the reading of the document and the productivity are estimated. For this reason, in the embodiment and the modification described above, it is possible to perform, for example, control or notification in consideration of the noise value and productivity, and thus, it is possible to achieve both prevention or reduction of giving discomfort to the surrounding people and maintenance of the productivity of document reading. The copiers according to the embodiments and the modification can enhance the comfort of the surrounding environment by prevention or reduction of giving discomfort to the surrounding people.

Although some embodiments for carrying out the present disclosure have been described above, the present invention is not limited to such embodiments at all, and various modifications and substitutions can be made without departing from the gist of the present invention. In addition, combinations of the respective elements described in the above-described embodiments can be appropriately changed as long as no technical contradiction occurs.

### A Description Is Given Below of Some Aspects of an Embodiment of the Present disclosure.

### Aspect 1

In Aspect 1, a document processing apparatus includes a tray, a conveyor, a reader, and circuitry. The tray stacks a document. The conveyor conveys the document from the tray. The reader reads an image on the document conveyed by the conveyor. The circuitry is to acquire processing information including a conveyance setting to set a conveyance condition of the document by the conveyor or a reading setting to set a reading condition of the document by the reader, estimate, based on the processing information acquired, magnitude of a sound generated by a conveyance of the document by the conveyor or a reading of the document by the reader and a reading number of sheets of the document processable per a given period of time, and change the conveyance setting based on the magnitude of the sound and the reading number.

### Aspect 2

In Aspect 2, in the document processing apparatus according to Aspect 1, the circuitry is further to estimate an acoustic comfort index of a sound generated by the conveyance or the reading of the document based on the processing information, and change the conveyance setting based on the acoustic comfort index.

### Aspect 3

In Aspect 3, in the document processing apparatus according to Aspect 2, the circuitry is further to receive information indicating a satisfaction level related to the sound generated by the conveyance or the reading of the document, and transmit, when the conveyance setting is changed, the conveyance setting before changing, the conveyance setting after changing, and the satisfaction level received.

### Aspect 4

In Aspect 4, in the document processing apparatus according to Aspect 1, the processing information further includes information of the document stacked on the tray.

### Aspect 5

In Aspect 5, in the document processing apparatus according to Aspect 1, the circuitry is further to output a notification related to a change in the conveyance setting based on the magnitude of the sound estimated, receive a selection of operation mode to change the conveyance setting, and change the conveyance setting according to the mode selected.

### Aspect 6

In Aspect 6, in the document processing apparatus according to Aspect 1, the circuitry is further to switch an operation mode between a first mode of the conveyance setting to convey the document based on the reading number and the magnitude of the sound and a second mode of the conveyance setting in which the reading number is smaller than the reading number of the first mode to reduce the magnitude of the sound to be smaller than the first mode.

### Aspect 7

In Aspect 7, the document processing apparatus according to Aspect 1 further includes a sound collector to collect sound around the document processing apparatus. The circuitry is further to determine whether to change the setting for the conveyor to convey the document based on the sound collected by the sound collector.

### Aspect 8

In Aspect 8, in the document processing apparatus according to Aspect 1, the circuitry is further configured to transmit a setting before a change and a setting after the change when the setting for the conveyor to convey the document is changed by the circuitry.

### Aspect 9

In Aspect 9, the document processing apparatus according to Aspect 1 further includes a communication device to communicate with an external apparatus. The circuitry is to transmit the processing information acquired by the circuitry to the external apparatus via the communication device, and receive an estimation result of the magnitude of the sound and the number of processable sheets of the document per a given period of time from the external apparatus.

### Aspect 10

In Aspect 10, an image forming apparatus includes an interface and circuitry. The interface communicably couples to a document processing apparatus including a tray, a conveyor, and a reader. The tray stacks a document. The conveyor conveys the document from the tray. The reader reads an image on the document conveyed by the conveyor. The circuitry is to acquire processing information including a conveyance setting to set a conveyance condition of the document by the conveyor or a reading setting to set a reading condition of the document by the reader and estimate, based on the processing information acquired, magnitude of a sound generated by a conveyance of the document by the conveyor or a reading of the document by the reader and a reading number of sheets of the document processable per a given period of time, and change the conveyance setting based on the magnitude of the sound and the reading number.

### Aspect 11

In Aspect 11, an image forming system includes an image forming apparatus and a document processing apparatus. The image forming apparatus includes a drive mechanism to drive to form an image. The document processing apparatus includes a tray, a conveyor, a reader, an interface, and circuitry. The tray stacks a document. The conveyor conveys the document from the tray. The reader reads an image on the document conveyed by the conveyor. The interface communicably couples to the image forming apparatus. The circuitry is to acquire processing information including a conveyance setting to set a conveyance condition of the document by the conveyor or a reading setting to set a reading condition of the document by the reader, estimate, based on the processing information acquired, magnitude of a sound generated by a conveyance of the document by the conveyor or a reading of the document by the reader and a reading number of sheets of the document processable per a given period of time, transmit information based on an estimation result of the magnitude of the sound and the reading number of sheets of the document processable per a given period of time, to the image forming apparatus, and cause the image forming apparatus to change a control of the drive mechanism based on the information received by the circuitry.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A document processing apparatus comprising:
a tray to stack a document;
a conveyor to convey the document from the tray;
a reader to read an image on the document conveyed by the conveyor; and
circuitry configured to:
acquire processing information including:
a conveyance setting to set a conveyance condition of the document by the conveyor; or
a reading setting to set a reading condition of the document by the reader;
estimate, based on the processing information acquired:
magnitude of a sound generated by:
a conveyance of the document by the conveyor; or
a reading of the document by the reader; and
a reading number of sheets of the document processable per a given period of time; and
change the conveyance setting based on:
the magnitude of the sound; and
the reading number.

2. The document processing apparatus according to claim 1,
wherein the circuitry is further configured to:
estimate an acoustic comfort index of a sound generated by the conveyance or the reading of the document based on the processing information; and
change the conveyance setting based on the acoustic comfort index.

3. The document processing apparatus according to claim 2,
wherein the circuitry is further configured to:
receive information indicating a satisfaction level related to the sound generated by the conveyance or the reading of the document; and
transmit, when the conveyance setting is changed:
the conveyance setting before changing;
the conveyance setting after changing; and
the satisfaction level received.

4. The document processing apparatus according to claim 1,
wherein the processing information further includes information of the document stacked on the tray.

5. The document processing apparatus according to claim 1,
wherein the circuitry is further configured to:
output a notification related to a change in the conveyance setting based on the magnitude of the sound estimated;
receive a selection of operation mode to change the conveyance setting; and
change the conveyance setting according to the mode selected.

6. The document processing apparatus according to claim 1,
wherein the circuitry is further configured to switch an operation mode between:
a first mode of the conveyance setting to convey the document based on the reading number and the magnitude of the sound; and
a second mode of the conveyance setting in which the reading number is smaller than the reading number of the first mode to reduce the magnitude of the sound to be smaller than the first mode.

7. The document processing apparatus according to claim 1, further comprising
a sound collector to collect sound around the document processing apparatus,
wherein the circuitry is further configured to determine whether to change the setting for the conveyor to convey the document based on the sound collected by the sound collector.

8. The document processing apparatus according to claim 1,
wherein the circuitry is further configured to transmit a setting before a change and a setting after the change when the setting for the conveyor to convey the document is changed by the circuitry.

9. The document processing apparatus according to claim 1, further comprising:
a communication device to communicate with an external apparatus,
wherein the circuitry is further configured to:
transmit the processing information acquired by the circuitry to the external apparatus via the communication device; and
receive an estimation result of the magnitude of the sound and the number of processable sheets of the document per a given period of time from the external apparatus.

10. An image forming apparatus comprising:
an interface to communicably couple to a document processing apparatus including:
a tray to stack a document;
a conveyor to convey the document from the tray; and
a reader to read an image on the document conveyed by the conveyor; and
circuitry configured to:
acquire processing information including:
a conveyance setting to set a conveyance condition of the document by the conveyor; or
a reading setting to set a reading condition of the document by the reader;
estimate, based on the processing information acquired:
magnitude of a sound generated by:
a conveyance of the document by the conveyor; or
a reading of the document by the reader; and
a reading number of sheets of the document processable per a given period of time; and
change the conveyance setting based on:
the magnitude of the sound; and
the reading number.

11. An image forming system comprising:
an image forming apparatus including a drive mechanism to drive to form an image; and
a document processing apparatus including:
a tray to stack a document;
a conveyor to convey the document from the tray;
a reader to read an image on the document conveyed by the conveyor;
an interface to communicably couple to the image forming apparatus; and
circuitry configured to:
acquire processing information including:
a conveyance setting to set a conveyance condition of the document by the conveyor; or
a reading setting to set a reading condition of the document by the reader;
estimate, based on the processing information acquired:
magnitude of a sound generated by:
a conveyance of the document by the conveyor; or
a reading of the document by the reader; and
a reading number of sheets of the document processable per a given period of time;
transmit information based on an estimation result of the magnitude of the sound and the reading number of sheets of the document processable per a given period of time, to the image forming apparatus; and
cause the image forming apparatus to change a control of the drive mechanism based on the information received by the circuitry.
